(19) United States
(12) Patent Application Publication
(10) Pub. No.: US 2008/0167744 A1
(43) Pub. Date: Jul. 10, 2008

(54) CONTROLLING DEVICE FOR SUBSTRATE PROCESSING APPARATUS AND METHOD THEREFOR

(75) Inventor: Shinji SAKANO, Nirasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 11/873,456

(22) Filed: Oct. 17, 2007

Related U.S. Application Data
(60) Provisional application No. 60/883,285, filed on Jan. 3, 2007.

(30) Foreign Application Priority Data
Oct. 17, 2006 (JP) JP2006-283031

(51) Int. Cl. G06F 19/00

(52) U.S. Cl. 700/108

(57) ABSTRACT

A TL performs a feed forward control and a feedback control of a PM. A storage unit stores a target value that serves as a control value when an etching process is performed on a wafer. A communication unit causes an IMM to measure a processing state of the wafer and receives measurement information. A computation unit computes a feedback value for the current wafer that is processed in the current cycle, based on pre-processing and post-processing measurement information. The computation unit computes a change value that is an amount of a change from a feedback value computed in a preceding cycle. A determination unit determines whether to discard the current computed feedback value by comparing the change value to a specified threshold value. An update unit, in a case where it is determined not to be discarded, uses the current computed feedback value in updating the target value.

### CROSS REFERENCE TO RELATED APPLICATIONS

The present invention contains subject matter related to Japanese Patent Application No. 2006-283031 filed in the Japan Patent Office on Oct. 17, 2006 and Provisional Application No. 60/883,285 filed on Jan. 3, 2007, the entire contents of which being incorporated herein by reference.

### BACKGROUND OF THE INVENTION

1. Field of the Invention

The present invention relates to a controlling device for a substrate processing apparatus that performs a specified process on a substrate, to a control method, and to a storage medium that stores a control program. More particularly, the present invention relates to an optimal adjustment of a feedback value when the specified process is performed by the substrate processing apparatus.

2. Description of the Related Art

When a desired process is performed in succession on a plurality of substrates, a reaction product that is generated during the process gradually adheres to an interior wall of a substrate processing apparatus, thereby gradually changing the atmosphere inside the substrate processing apparatus. A feed forward control and a feedback control have been proposed for some time in order to perform the substrate processing with constantly good precision while adapting to the changing atmosphere (for example, refer to Japanese Patent Application Publication No. JP-A-2004-207703.)

In the feedback control, for example, in a case where an etching process is performed on the substrate, the state of the substrate surface is measured by a measuring instrument before and after the etching process. The measurements of the state of the substrate surface before and after processing are used to determine the extent to which the actual amount of material removed from the substrate deviates from a target value. Based on the amount of the deviation, a feedback value, such as the etching amount per unit time, for example, is computed, and the computed feedback value is used in an updating of the target value. In this manner, the target value is constantly optimized so that it reflects the current changes in the atmosphere inside the substrate processing apparatus.

In the feed forward control, the most recent target value determined by the feedback control is defined as a control value, and the specified processing of the substrate is performed based on the control value. For example, in a case where the target value is the etching amount per unit time, even if the atmosphere in the substrate processing apparatus gradually changes, the substrate is processed well according to the etching amount per unit time, which is varied according to the changes in the atmosphere inside the substrate processing apparatus.

In Japanese Patent Application Publication No. JP-A-2004-207703, in a case where the current computed feedback value is greater than an upper limit value at which it is possible for the substrate processing apparatus to be controlled, due to the limits of the performance of the substrate processing apparatus, the computed feedback value is discarded. For example, in a case where the feedback value indicates the power that is applied inside the substrate processing apparatus, if the most recent feedback value is greater than the maximum power that can be applied to the substrate processing apparatus, the feedback value is assumed to contain a large error. In this case, if the feedback value is used in the updating of the target value, the target value will deviate from a value (an ideal value) that reflects the current atmosphere inside the substrate processing apparatus. Accordingly, in Japanese Patent Application Publication No. JP-A-2004-207703, the current computed feedback value is discarded, and good processing precision for the substrate is maintained by keeping the target value as is.

### SUMMARY OF THE INVENTION

However, with only the feedback control described above, there are still cases in which the target value deviates from the ideal value. For example, in a case where the change from the feedback value computed in the preceding cycle to the current computed feedback value is a small change that is considered to be at the level of an error, then if the current feedback value is used in the updating of the target value, the error will be incorporated into the target value, causing unnecessary fluctuation in the target value, such that the target value will deviate from the ideal value that reflects the current atmosphere inside the substrate processing apparatus.

Furthermore, in a case where the change from the feedback value computed in the preceding cycle to the current computed feedback value sporadically becomes a large variation, then if the current feedback value is used in the updating of the target value, a large error will be incorporated into the target value, causing a large fluctuation in the target value, such that the target value will deviate from the ideal value that reflects the current atmosphere inside the substrate processing apparatus.

Accordingly, the one embodiment of the present invention provides a controlling device for a substrate processing apparatus, the controlling device computes more precisely the target value that serves as the control value during feedback control based on the extent of the change in the feedback value. The present invention also provides a control method thereof and a storage medium that stores a control program.

Specifically, the one embodiment of the present invention, there is provided a controlling device for the substrate processing apparatus that performs a specified process on a substrate. The controlling device includes a storage unit, a communication unit, a computation unit, a determination unit, and an update unit. The storage unit stores the specified target value that serves as the control value when the specified process is performed on the substrate. The communication unit causes a measuring device to measure measurement information including a processing state of the substrate that is processed by the substrate processing apparatus and receives the measurement information. The computation unit computes a feedback value that corresponds to a processed state of the substrate processed in the current cycle, based on pre-processing and post-processing measurement information for the substrate processed in the current cycle within the measurement information received by the communication unit. The computation unit also computes a feedback value change value between the current computed feedback value and at least any one of feedback values that was computed before the current cycle. The determination unit determines whether or not to discard the current computed feedback value by comparing the feedback value change value that was computed by the computation unit to a given threshold value. In a case where the determination unit determines that the current computed feedback value will not be discarded, the update unit uses the current computed feedback value in updating the target value that is stored in the storage unit.

In this aspect, one example of the specified target value is a parameter that serves as a process condition. The parameter may be a substrate processing time (for example, an amount of etching per unit time), a pressure within the substrate processing apparatus, an electric power that is applied to the substrate processing apparatus, a temperature at a specified position in the substrate processing apparatus (for example, one of an upper electrode, a lower electrode, a stage, and an interior wall of the apparatus), a mixture ratio of a plurality of types of gases that are supplied to the substrate processing apparatus, a gas flow volume that is supplied to the substrate processing apparatus, and the like.

The feedback value change value may be the difference between the current computed feedback value and at least any one of feedback values that was computed before the current cycle. For example, the feedback value change value may be the amount of the change from the feedback value that was computed in the preceding cycle to the current computed feedback value. The feedback value change value may also be the amount of the change from the target value to the current computed feedback value.

According to this aspect, attention is focused on the feedback value change value, and the feedback value change value is treated as a value that corresponds to the change in the atmosphere inside the substrate processing apparatus. The answer to the question of whether or not the feedback value change value reflects the change in the atmosphere inside the substrate processing apparatus is inferred by comparing the feedback value change value to the given threshold value for determining whether or not the feedback value change value reflects the change in the atmosphere inside the substrate processing apparatus.

Only in a case where the result of the comparison is that the feedback value change value is inferred to reflect the change in the atmosphere inside the substrate processing apparatus, the current computed feedback value is used in updating the target value. It is thus possible to prevent the target value from deviating from the ideal value that reflects the current atmosphere inside the substrate processing apparatus by discarding a feedback value that does not reflect the change in the atmosphere inside the substrate processing apparatus. The next substrate that is conveyed into the substrate processing apparatus can thus be processed with good precision.

A case will be explained where it is inferred that the feedback value change value does not reflect the change in the atmosphere inside the substrate processing apparatus. For example, if the given threshold value includes a first threshold value, and the first threshold value is set in advance, according to the performance of the measuring device, to a value that is less than a lower limit value that is measurable by the measuring device, then in a case where the absolute value of the feedback value change value is equal to or less than the first threshold value, it is inferred that the feedback value change value does not reflect the change in the atmosphere inside the substrate processing apparatus.

For example, in a case where the measuring device cannot measure down to the 1 nm level without an error, it is assumed that many measurement errors that arise from variations with values of less than 1 nm are included in changes in the feedback value. In this sort of case, if the current computed feedback value is used in the updating of the target value, the measurement errors will cause the target value to fluctuate unnecessarily, and the target value will therefore deviate from the ideal value that corresponds to the current atmosphere inside the substrate processing apparatus.

Accordingly, if this controlling device is used, in a case where the absolute value of the feedback value change value is equal to or less than the first threshold value, the current computed feedback value is discarded, and the target value is maintained as is, without being updated. It is thus possible to avoid unnecessary fluctuation in the target value due to errors that arise during measurement, and it is possible the maintain the target value at or near the ideal value that corresponds to the current atmosphere inside the substrate processing apparatus. It is therefore possible to perform the specified process with good precision on the next substrate that is conveyed into the substrate processing apparatus.

Another case will be explained where it is inferred that the feedback value change value does not reflect the change in the atmosphere inside the substrate processing apparatus. For example, if the given threshold value includes a second threshold value, and the second threshold value is set in advance, based on a permissible upper limit value for the value of a change in a process condition that controls the substrate processing apparatus, to a value that is greater than an upper limit value that is predicted as the feedback value change value, then in a case where the absolute value of the feedback value change value is equal to or greater than the second threshold value, it is inferred that the feedback value change value does not reflect the change in the atmosphere inside the substrate processing apparatus.

For reasons such as that during processing a reaction product gradually adheres to an interior wall of the substrate processing apparatus and the like, the atmosphere inside the substrate processing apparatus slowly changes over time. It is thought that the feedback value changes gradually according to the changes in the atmosphere. For this reason, in a case where the amount of change in the feedback value suddenly becomes large, for example, the feedback value is assumed to contain a large error. If the current computed feedback value is used in the updating of the target value, even in this sort of case, the target value will fluctuate greatly, and the target value will deviate from the ideal value that corresponds to the current atmosphere inside the substrate processing apparatus.

In the computation of the target value, a moving average is used as a method of obtaining an average of the values of the feedback values over a period of time, gradually shifting the period of time for which the average is obtained to provide the moving average. Specifically, a type of moving average called an exponentially weighted moving average (EWMA) is used. EWMA is an exponential smoothing method that applies weighting such that the most recent feedback value is treated as more important than the past feedback values. Where EWMA is compute the target value, any error resulting from a sudden, large change in the feedback value will affect the subsequent computations of the target value for a long time.

Accordingly, if this controlling device is used, in a case where the absolute value of the feedback value change value is equal to or greater than the second threshold value, the current computed feedback value is discarded, and one of maintaining the target value as is, without updating it, and updating the target value according to the second threshold value is done. It is thus possible to prevent the target value from deviating greatly from the ideal value because a feedback value that contains a large error is used in the updating of the target value. It is therefore possible to perform the specified process on the substrate with good precision.

Note that a process condition that is used when the second threshold value is determined may be one of a pressure within the substrate processing apparatus, an electric power within the substrate processing apparatus, a temperature at a specified position in the substrate processing apparatus (for example, one of an upper electrode, a lower electrode, a stage, and an interior wall of the apparatus), a mixture ratio of a plurality of types of gases that are supplied to the substrate processing apparatus, a gas flow volume that is supplied to the substrate processing apparatus, an amount of etching per unit time, and the like.

A further example will be explained where it is inferred that the feedback value change value does not reflect the change in the atmosphere inside the substrate processing apparatus. For example, if the given threshold value includes a third threshold value, and the third threshold value is set in advance, according to the performance of the substrate processing apparatus, to a value that is greater than an upper limit value that the substrate processing apparatus can control, then in a case where the current computed feedback value is equal to or greater than the third threshold value, it is inferred that the feedback value change value does not reflect the change in the atmosphere inside the substrate processing apparatus.

In a case where the current computed feedback value is a value that is greater than an upper limit value that the substrate processing apparatus can control, due to the limits of the performance of the substrate processing apparatus, the feedback value is assumed to be a value that has deviated from the ideal value that corresponds to the current atmosphere inside the substrate processing apparatus. For example, in a case where the feedback value indicates the power that is input to the substrate processing apparatus, if the current feedback value is greater than a value that can be achieved by the maximum power that can be input to the substrate processing apparatus, it is inferred that the feedback value contains a large error. In this case, if the current feedback value were to be reflected in the updating of the target value, the target value would deviate from the ideal value that corresponds to the current atmosphere inside the substrate processing apparatus.

Accordingly, if this controlling device is used, in a case where the current computed feedback value is equal to or greater than the third threshold value, the current computed feedback value is discarded, and one of maintaining the target value as is, without updating it, and updating the target value according to the third threshold value is done. It is thus possible to prevent the target value from deviating greatly from the ideal value because a feedback value that contains a large error is used in the updating of the target value. It is therefore possible to perform the specified process on the substrate with good precision.

The target value can be optimized by discarding any feedback value that is assumed to contain many errors, as described above. During the feed forward control, the specified process can thus be adapted to the changes that occur over time inside the substrate processing apparatus, based on the optimized target value. It is therefore possible to perform the specified process with good precision on the substrate that is conveyed into the substrate processing apparatus.

Furthermore, the controlling device may also control a plurality of the substrate processing apparatuses. In this case, the controlling device may provide the target value separately for each of the substrate processing apparatuses. The controlling device may also determine separately whether or not to use the current computed feedback value computed separately for each of the substrate processing apparatuses in the respective updating of each of the target values for each of the substrate processing apparatuses. The controlling device may also separately perform, based on each of the target values that are determined as a result of the separate determinations, the feed forward control for each of the substrates that are conveyed into each of the respective substrate processing apparatuses.

If this configuration is used, for example, each of the plurality of the substrate processing apparatuses that are provided in various areas within a plant can be separately and independently controlled by the controlling device. Thus, during the feedback control, the optimized target value can be computed separately for each of the substrate processing apparatuses. Therefore, when the specified processes are performed on the substrates in each of the substrate processing apparatuses, the specified processes can be adapted to the changes that occur over time inside each of the substrate processing apparatuses, based on the optimized target values. It is therefore possible to perform the specified processes with good precision on the substrates that are conveyed into the substrate processing apparatuses.

The specified process may also be an etching process. Other examples of the specified process include a deposition process, an ashing process, and a spattering process.

The received measurement information may also be information for computing at least one of a substrate critical dimension (CD), an etching rate, and a deposition rate. Note that the CD denotes an amount of shift in a post-etching pattern dimension in relation to a pre-etching mask dimension.

Further, according to another embodiment of the present invention, there is provided a control method for controlling a substrate processing apparatus that performs a specified process on a substrate. The control method includes a step of storing in a storage unit a specified target value that serves as a control value when the specified process is performed on the substrate. The control method also includes a step of causing a measuring device to measure measurement information including a processing state of the substrate that is processed by the substrate processing apparatus and a step of receiving the measurement information. The control method also includes a step of computing a feedback value that corresponds to a processed state of the substrate processed in the current cycle, based on pre-processing and post-processing measurement information for the substrate processed in the current cycle within the received measurement information. The control method also includes a step of computing a feedback value change value between the current computed feedback value and at least any one of feedback values that was computed before the current cycle. The control method also includes a step of determining whether or not to discard the current computed feedback value by comparing the computed feedback value change value to a given threshold value. The control method also includes a step of using, in a case where it is determined that the current computed feedback value will not be discarded, the current computed feedback value in updating the target value that is stored in the storage unit.

According to another embodiment of the present invention, there is also provided a storage medium that stores a control program for a substrate processing apparatus that performs a specified process on a substrate, to control the substrate processing apparatus by executing the control program with a computer, the control program including: a module stores in a storage unit a specified target value that serves as a control value when the specified process is performed on the substrate; a module that causes a measuring device to measure measurement information including a processing state of the substrate that is processed by the substrate processing apparatus, and that receives the measurement information; a module that computes a feedback value that corresponds to a processed state of the substrate processed in the current cycle, based on pre-processing and post-processing measurement information for the substrate processed in the current cycle within the received measurement information, and that also computes a feedback value change value between the current computed feedback value and at least any one of feedback values that was computed before the current cycle; a module that determines whether or not to discard the current computed feedback value by comparing the computed feedback value change value to a given threshold value; and a module that, in a case where it is determined that the current computed feedback value will not be discarded, uses the current computed feedback value in updating the target value that is stored in the storage unit.

According to these aspects, it is possible to prevent the target value from deviating from the ideal value that corresponds to the current atmosphere inside the substrate processing apparatus by determining whether or not the current feedback value should be used in the updating of the target value, based on the feedback value change value.

As explained above, according to the present invention, the target value that serves as the control value during feedback control can be computed more precisely, based on the extent of the change in the feedback value.

### BRIEF DESCRIPTION OF THE DRAWINGS

FIG. 1 is a figure that shows a substrate processing system according to an embodiment of the present invention;

FIG. 2 is a layout drawing of various devices in a plant area Q according to the embodiment;

FIG. 3 is a figure that schematically shows a vertical cross section of a process module (PM) according to the embodiment;

FIG. 4 is a hardware configuration diagram that shows a tool level (TL) and the like according to the embodiment;

FIG. 5 is a functional configuration diagram that shows the TL according to the embodiment;

FIG. 6 is a figure that shows examples of a unit of data that is held in a storage unit;

FIG. 7 is a figure that shows examples of a unit of data that is contained in a process recipe;

FIG. 8A is a figure that shows a stage of a TRANSFER ROUTE for a wafer W;

FIG. 8B is a figure that shows another stage of the TRANSFER ROUTE for the wafer W;

FIG. 8C is a figure that shows another stage of the TRANSFER ROUTE for the wafer W;

FIG. 8D is a figure that shows another stage of the TRANSFER ROUTE for the wafer W;

FIG. 8E is a figure that shows another stage of the TRANSFER ROUTE for the wafer W;

FIG. 9A is a figure that shows a stage of a trimming process for a gate electrode that is formed from polysilicon;

FIG. 9B is a figure that shows another stage of the trimming process for the gate electrode that is formed from polysilicon;

FIG. 9C is a figure that shows another stage of the trimming process for the gate electrode that is formed from polysilicon;

FIG. 9D is a figure that shows another stage of the trimming process for the gate electrode that is formed from polysilicon;

FIG. 9E is a figure that shows another stage of the trimming process for the gate electrode that is formed from polysilicon;

FIG. 9F is a figure that shows another stage of the trimming process for the gate electrode that is formed from polysilicon;

FIG. 9G is a figure that shows another stage of the trimming process for the gate electrode that is formed from polysilicon;

FIG. 10 is a flow chart that shows a measurement information accumulation processing routine that is performed in the embodiment;

FIG. 11 is a flow chart that shows a feed forward/feedback control processing routine that is performed in the embodiment;

FIG. 12 is a flow chart that shows a feedback control processing routine that is performed in the embodiment;

FIG. 13 is a flow chart that shows a feedback value adjustment processing routine that is performed in the embodiment;

FIG. 14 is a flow chart that shows a minimum change adjustment processing routine that is called by the feedback value adjustment processing routine;

FIG. 15 is an explanatory figure of changes made in a target value by the minimum change adjustment processing routine;

FIG. 16 is a flow chart that shows a maximum change adjustment processing routine that is called by the feedback value adjustment processing routine;

FIG. 17 is an explanatory figure of changes made in the target value by the maximum change adjustment processing routine;

FIG. 18 is a flow chart that shows a limit adjustment processing routine that is called by the feedback value adjustment processing routine;

FIG. 19 is an explanatory figure of changes made in the target value by the limit adjustment processing routine;

FIG. 20 is another layout drawing of various devices in the plant area Q;

FIG. 21 is another layout drawing of various devices in the plant area Q; and

FIG. 22 is a figure that schematically shows a vertical cross section of another interior structure of the process module (PM).

### DETAILED DESCRIPTION OF THE EMBODIMENTS

Hereinafter, a preferred embodiment of the present invention will be described in detail with reference to the appended drawings. Note that, in this specification and the appended drawings, structural elements that have substantially the same function and structure are denoted with the same reference numerals, and repeated explanation of these structural elements is omitted.

Note that in this specification, 1 Torr equals (101325/760) Pa, and 1 sccm equals (10⁻⁶/60) mm³/sec.

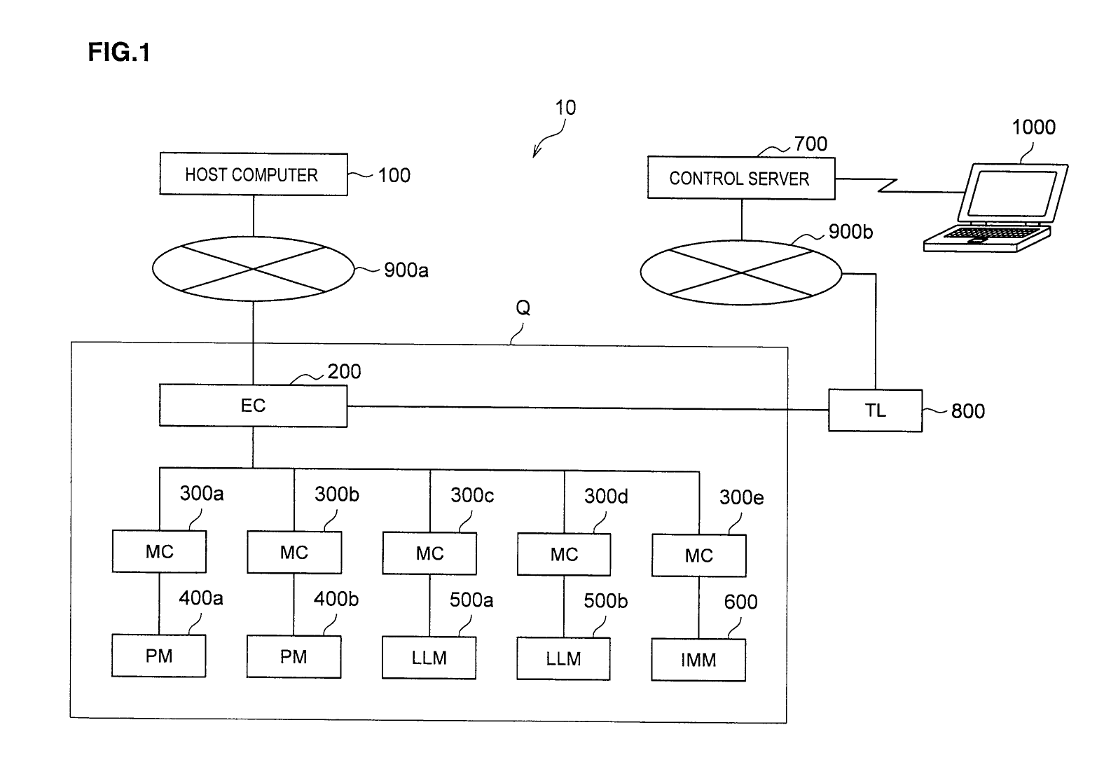

First, a general description of a substrate processing system that uses a controlling device according to the embodiment of the present invention will be provided with reference to FIG. 1. Note that in the present embodiment, a process that uses the substrate processing system to etch a silicon wafer (hereinafter called the “wafer”) will be used as an example for explanatory purposes.

Substrate Processing System

A substrate processing system 10 includes a host computer 100, an equipment controller (hereinafter called the “EC”) 200, five machine controllers (hereinafter called the “MCs”) 300a to 300e, two process modules (hereinafter called the “PMs”) 400a and 400b, two load lock modules (hereinafter called the “LLMs”) 500a and 500b, one measuring instrument module (hereinafter called the “integrated metrology module” (IMM)) 600, a control server 700, and a process adjustment controller (hereinafter called the “tool level” (TL)) 800.

The host computer 100 and the EC 200 are connected by a client local area network (LAN) 900a, and the control server 700 and the TL 800 are connected by a client LAN 900b. In addition, the control server 700 is connected to an information processing device, such as a personal computer (PC) 1000 or the like, and is in a state where it can be accessed by an operator.

The EC 200, the MCs 300a to 300e, the PMs 400a, 400b, the LLMs 500a, 500b, and the IMM 600 are provided in a specified area Q within a plant. The TL 800 and the EC 200, as well as the EC200 and the five MCs 300, are connected by in-plant LANs. The same sort of in-plant LANs connect each of the MCs 300 to one of the PMs 400a, 400b, the LLMs 500a, 500b, and the IMM 600.

The host computer 100 controls the entire substrate processing system 10, including data control and the like. The EC 200 holds a process recipe that is used for the process of etching a substrate. The EC 200 transmits instruction signals to each of the MCs 300 such that the desired etching process is performed on the substrate by the PMs 400a, 400b according to the process recipe. The EC 200 also performs revision history control and the like for the process recipes that are used.

The MCs 300a to 300d, by respectively controlling the PMs 400a, 400b and the LLMs 500a, 500b based on the instruction signals that are transmitted from the EC 200, control the transfer of the wafer W and control the PMs 400a, 400b such that they perform the etching process according to the process recipe. Data that indicate changes in the process conditions (for example, changes over time in a temperature, a pressure, a gas flow volume, and the like) are transmitted from the MCs 300a to 300d to the host computer 100 through the EC 200.

The IMM 600 measures the processing state of the surface of the wafer W before the etching process and the processing state of the surface of the wafer W after the etching process. The measurement data are transmitted from the MC 300e to the TL 800 through the EC 200. Note that the method of measuring the state of the surface of the wafer W will be described later.

The control server 700, based on data that are transmitted from the PC 1000 by an operation of the operator, generates a strategy that sets operating conditions for each device. Specifically, the control server 700 generates a strategy that contains data related to a system recipe to control each device that is disposed within the area Q, data related to a feedback plan to perform a feedback control, and data related to a feed forward plan to perform a feed forward control.

The TL 800 stores the strategy that is generated by the control server 700. Based on the feedback plan, the TL 800 computes a pre-processing critical dimension (CD) value (CDb) and a post-processing CD value (CDa) based on the measurement information measured by the IMM 600. The TL 800 uses each CD value to compute a feedback value and uses an exponentially weighted moving average (EWMA) to compute, based on the current feedback value and a feedback value computed before the current cycle, a target value that serves as a control value during the feed forward control (the feedback control). Furthermore, based on the feed forward plan, the TL 800 controls, according to the target value computed during the feedback control, the etching process for the next wafer W that will be transferred to the PMs 400 (the feed forward control).

Hardware Configurations of the PMs, the LLMs, and the IMM

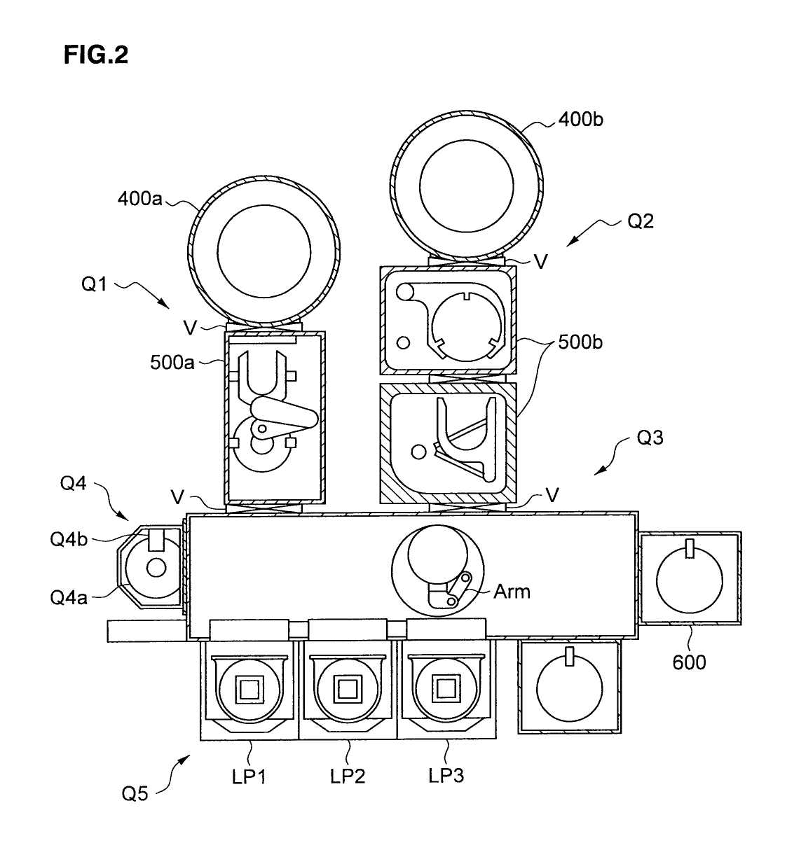

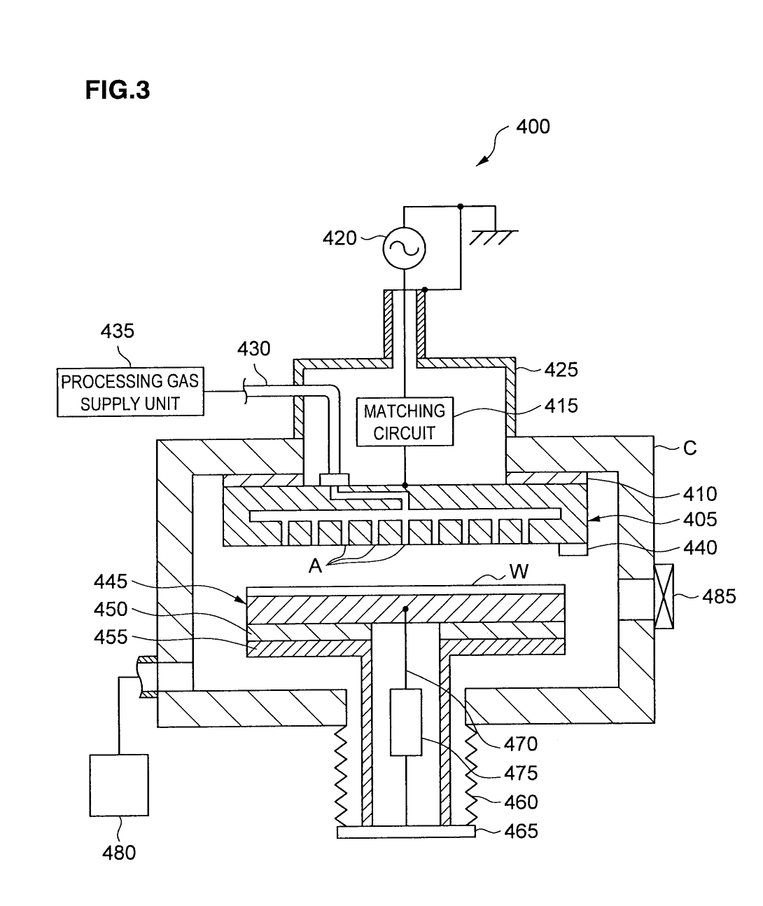

Next, the hardware configurations of the PMs 400, the LLMs 500, and the IMM 600 that are disposed in the specified area Q within the plant will be explained with reference to FIGS. 2 and 3. As shown in FIG. 2, a first process ship Q1, a second process ship Q2, a transfer unit Q3, an alignment mechanism Q4, and a cassette stage Q5 are disposed in the specified area Q within the plant.

The first process ship Q1 includes the PM 400a and the LLM 500a. The second process ship Q2 is arranged parallel to the first process ship Q1 and includes the PM 400b and the LLM 500b. The PMs 400a, 400b use a plasma to perform a specified process (for example, an etching process) on the wafer W. The PMs 400 correspond to the substrate processing apparatus that performs the specified processing on the substrate. The TL 800 is an example of the controlling device that controls the substrate processing apparatus. Note that details of the internal structure of the PMs 400 will be described later.

The LLMs 500a, 500b transfer the wafer W between the transfer unit Q3, which is open to the atmosphere, and the PMs 400a, 400b, which are in a vacuum state by the opening and closing of gate valves V, which are provided at both ends of the LLMs 500a, 500b and can open and close in an airtight manner.

The transfer unit Q3 is a rectangular transfer chamber and is connected to the first process ship Q1 and the second process ship Q2. The transfer unit Q3 is provided with a transfer arm (Arm), and the Arm is used to convey the wafer W to one of the first process ship Q1 and the second process ship Q2.

The alignment mechanism Q4, which performs aligning of the wafer W, is provided at one end of the transfer unit Q3. The alignment mechanism Q4 aligns the wafer W by rotating a rotating platform Q4a on which the wafer W is placed and using an optical sensor Q4b to detect the state of the outer edge of the wafer W.

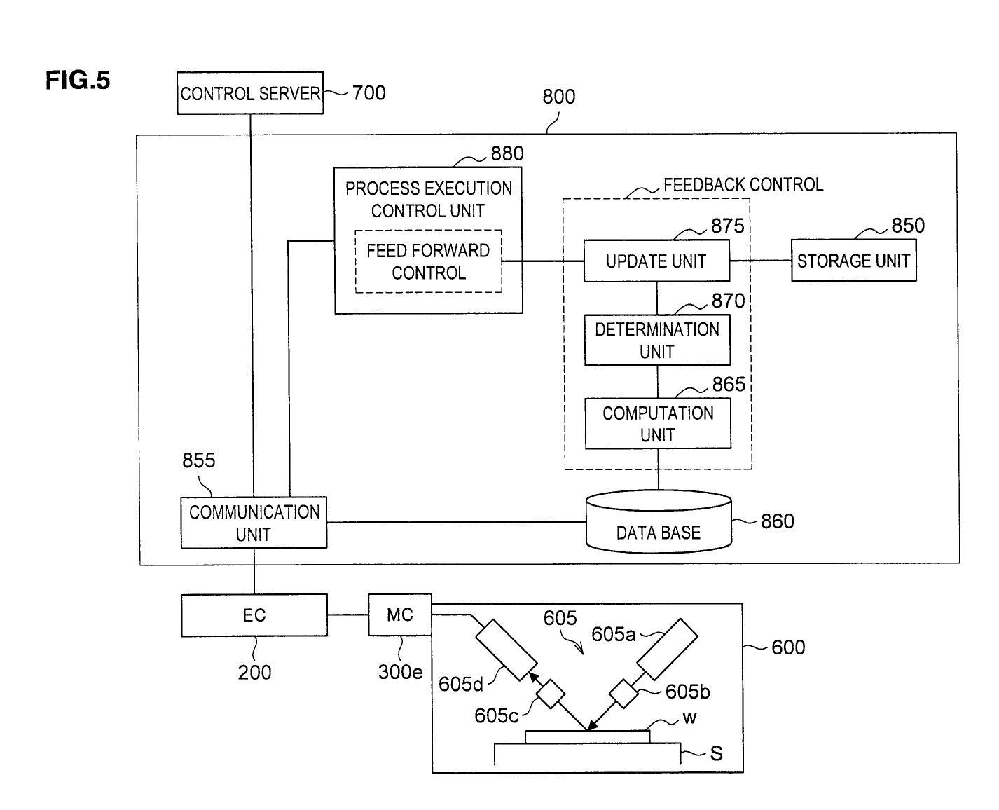

The IMM 600 is provided at the other end of the transfer unit Q3. As shown in the lower unit of FIG. 5, the IMM 600 includes an optical unit 605. The optical unit 605 includes a light-emitting device 605a, a light polarizer 605b, an analyzer 605c, and a light-receiving device 605d.

The light-emitting device 605a outputs white light in the direction of the wafer W. The light polarizer 605b converts the output white light to linear polarized light, then irradiates the wafer W, which is placed on a stage S. From the elliptically polarized light that is reflected from the wafer W, the analyzer 605c allows only the polarized light with a specific polarized angle to pass through. The light-receiving device 605d is made up of a charge-coupled device (CCD) camera or the like, for example, and receives the polarized light that passes through the analyzer 605c. The light-receiving device 605d converts the received polarized light into an electrical signal and outputs the converted electrical signal to the MC 300e. The electrical signal that is output to the MC 300e is transmitted to the TL 800 through the EC 200.

Returning to FIG. 2, the cassette stage Q5 is provided on a side face of the transfer unit Q3. Three cassette holders LP1 to LP3 are placed on the cassette stage Q5. A maximum of twenty-five wafers W, for example, is accommodated on a plurality of levels in each cassette holder LP.

If the configuration described above is used, the transfer unit Q3 transfers the wafer W among the cassette stage Q5, the alignment mechanism Q4, the IMM 600, and the processing ships Q1, Q2.

Internal Structure of the PMs

The internal structure of the PMs 400 will be explained with reference to a vertical cross section of the PMs 400 that is schematically shown in FIG. 3.

Each of the PMs 400 has a rectangular tube-shaped processing container C that has openings approximately in a center unit of its top unit and approximately in a center unit of its bottom unit. The processing container C is built, for example, from aluminum with an anodized surface.

An upper electrode 405 is provided in an upper unit of the interior of the processing container C. The upper electrode 405 is electrically isolated from the processing container C by an insulating material 410 that is provided around the edge of the opening in the top unit of the processing container C. A high-frequency power supply 420 is connected to the upper electrode 405 through a matching circuit 415. A matching box 425 is provided that surrounds the matching circuit 415 and serves as a grounded housing for the matching circuit 415.

A processing gas supply unit 435 is connected to the upper electrode 405 by a gas line 430. A desired processing gas that is supplied by the processing gas supply unit 435 is introduced into the processing container C through a plurality of gas injection holes A. Thus the upper electrode 405 functions as a gas shower head. A temperature sensor 440 is provided on the upper electrode 405. The temperature sensor 440 detects the temperature of the upper electrode 405 as the temperature inside the processing container C.

A lower electrode 445 is provided in a lower unit of the interior of the processing container C. The lower electrode 445 functions as a susceptor on which the wafer W is placed. The lower electrode 445 is supported through an insulating material 450 by a support member 455. The lower electrode 445 is thus electrically isolated from the processing container C.

One end of a bellows 460 is attached close to the perimeter of the opening that is provided in the bottom face of the processing container C. A raising and lowering plate 465 is securely fixed to the other end of the bellows 460. According to this configuration, the opening in the bottom face of the processing container C is sealed by the bellows 460 and the raising and lowering plate 465. Furthermore, the bellows 460 and the raising and lowering plate 465 move up and down as a single unit to adjust the position of the lower electrode 445 on which the wafer W is placed to a height that is appropriate to the processing.

The lower electrode 445 is connected to the raising and lowering plate 465 through an electrically conductive path 470 and an impedance adjustment unit 475. The upper electrode 405 and the lower electrode 445 respectively correspond to a cathode electrode and an anode electrode. The pressure in the interior of the processing container C is lowered to a desired degree of vacuum by an exhaust mechanism 480. According to this configuration, with the wafer W having been conveyed into the interior of the processing container C, high-frequency electric power is applied to excite the gas that is supplied to the interior of the processing container C and generate a plasma, while the airtightness of the processing container C is maintained by the opening and closing of a gate valve 485. The desired etching of the wafer W is performed by the action of the generated plasma.

Hardware Configurations of the TL

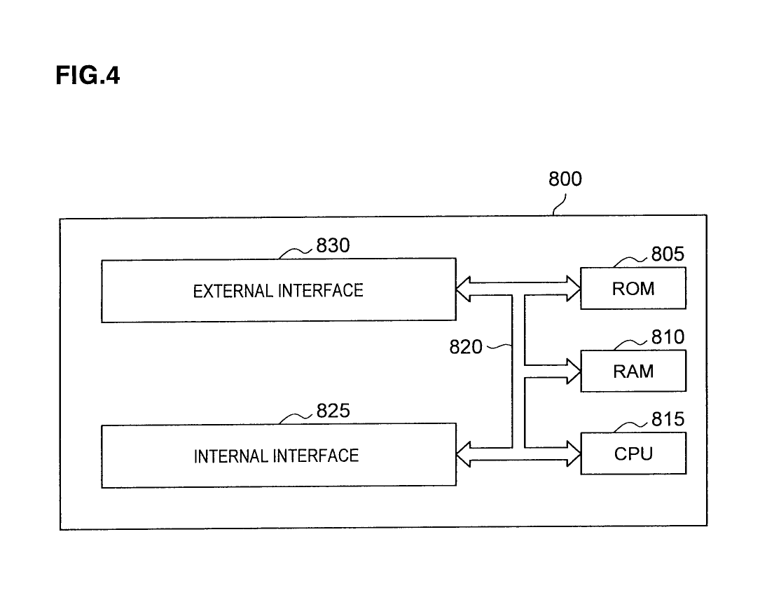

Next, the hardware configuration of the TL 800 will be explained with reference to FIG. 4. Note that the hardware configurations of the EC 200, the MCs 300, the control server 700, and the host computer 100 are the same as that of the TL 800, so explanation of these configurations is omitted.

As shown in FIG. 4, the TL 800 includes a ROM 805, a RAM 810, a CPU 815, a bus 820, an internal interface (internal I/F) 825, and an external interface (external I/F) 830.

A basic program that is run by the TL 800, a program that is run when an abnormality occurs, various types of recipes, and the like are stored in the ROM 805. Various types of programs and data are stored in the RAM 810. Note that the ROM 805 and the RAM 810 are examples of storage devices and may be storage devices such as EEPROMs, optical disks, magneto-optical disks, and the like.

The CPU 815 controls the substrate processing according to the various types of recipes. The bus 820 is the path by which data is exchanged among the ROM 805, the RAM 810, the CPU 815, the internal interface 825, and the external interface 830.

The internal interface 825 inputs data and outputs required data to a monitor, a speaker, and the like that are not shown in the drawings. The external interface 830 transmits and receives data among devices that are connected in a network such as a LAN or the like.

Functional Configuration of the TL 800

Next, various functions of the TL 800 will be explained with reference to FIG. 5, which shows the functions as blocks. The TL 800 includes the functions shown by the various blocks, including a storage unit 850, a communication unit 855, a data base 860, a computation unit 865, a determination unit 870, an update unit 875, and a process execution control unit 880.

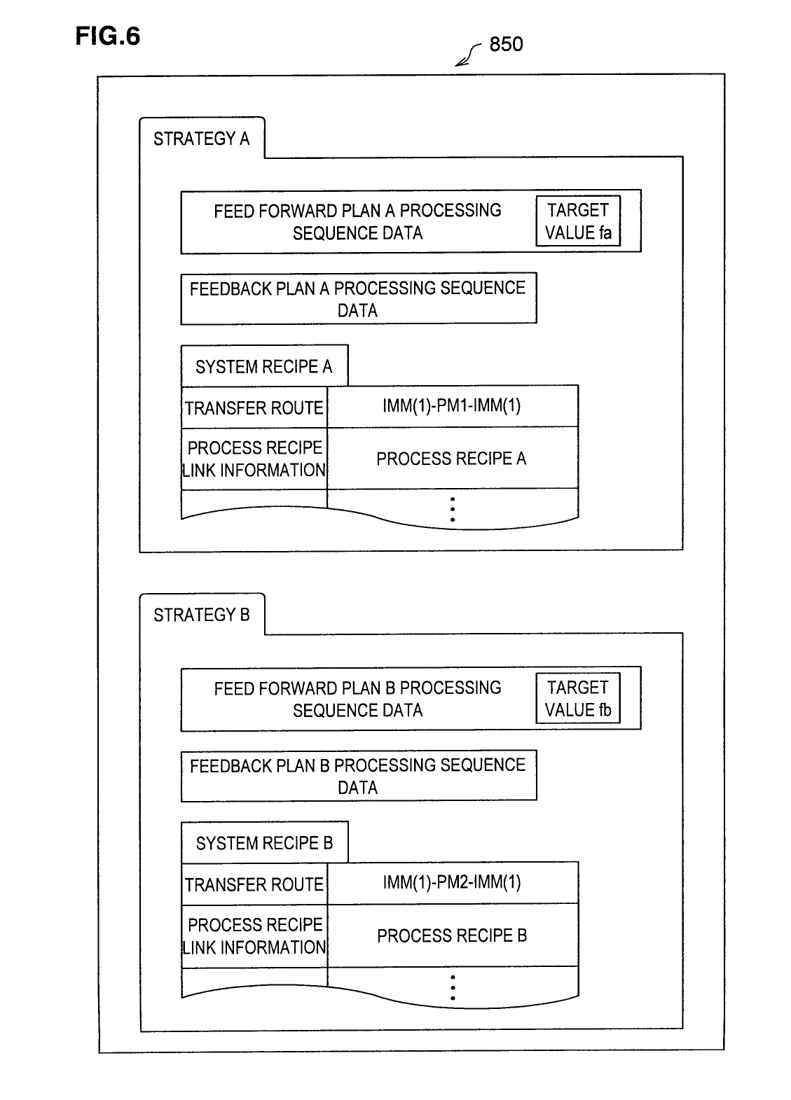

As shown in FIG. 6, a plurality of strategies that set the operating conditions for performing various types of processes are stored in the storage unit 850. In the present embodiment, strategies A,B are stored in the storage unit 850. The storage unit 850 stores the strategies that are sent from the control server 700 at a point when communication with the control server 700 is established and at a point when it becomes possible for a new strategy to be used. In addition, at a point when it becomes impossible to use any given stored strategy, the storage unit 850 deletes the strategy in question.

Each strategy contains a feed forward plan that indicates a processing sequence for the feed forward control, a feedback plan that indicates a processing sequence for the feedback control, and a system recipe that indicates a sequence for the process of etching the wafer W. For example, a strategy A contains a feed forward plan A, a feedback plan A, and a system recipe A, and a strategy B contains a feed forward plan B, a feedback plan B, and a system recipe B.

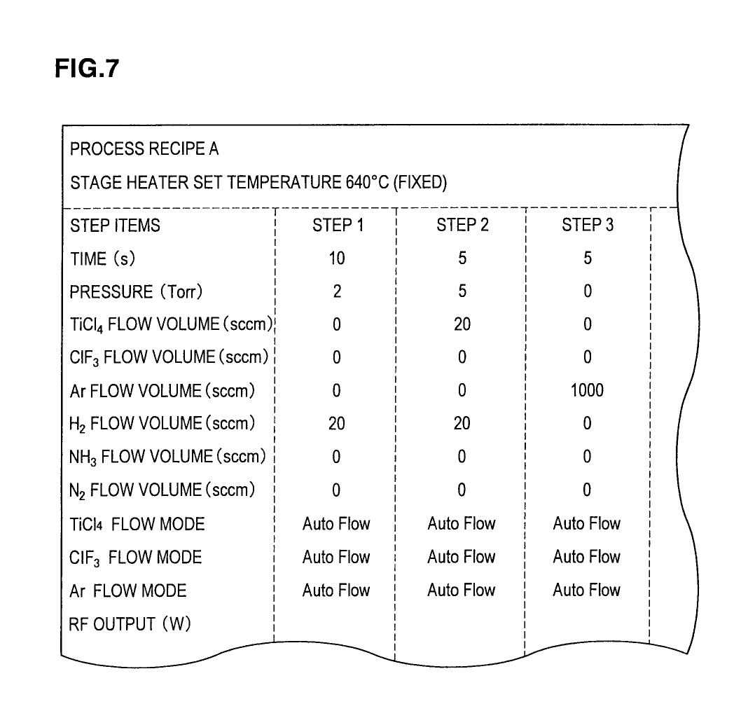

The feed forward plans A, B contain the target values f (fa, fb) that serve as the control values when the etching process is performed on the wafer W. In the present embodiment, the target values fa, fb are etching amounts per unit time. The system recipes A, B contain TRANSFER ROUTEs for the wafer W in the strategies A, B and link information for an applicable process recipe. For example, the system recipe A indicates, based on the TRANSFER ROUTE, that the wafer W is transferred to an IMM (1) (the IMM 600), then is transferred to a PM 1 (the PM 400a), and finally is transferred again to the IMM (1). The system recipe A also indicates, based on the link information for the applicable process recipe, that the wafer W is etched according to a processing sequence in the process recipe A that is shown as an example in FIG. 7.

The communication unit 855 receives, through the MC 300e and the EC 200, the measurement information that indicates the processing state of the surface of the wafer W and that was measured and converted into an electrical signal by the IMM 600, as described above. Specifically, every time the wafer W is transferred into the IMM 600 based on the TRANSFER ROUTE indicated in the system recipe, the processing state of the surface of the wafer W is measured and converted into the electrical signal that the communication unit 855 receives as the measurement information. Therefore, in the case where the TRANSFER ROUTE is the IMM (1) to the PM 1 to the IMM (1), for each wafer W, the communication unit 855 receives as the measurement information the state of the wafer W before it is etched by the PM 1 and receives as the measurement information the state of the wafer W after it is etched by the PM 1. The measurement information that is received by the communication unit 855 is stored and accumulated in the data base 860.

Based on the measurement information from before and after the current etching process, which is in the measurement information that is received by the communication unit 855 and accumulated in the data base 860, the computation unit 865 computes a feedback value fₓ that corresponds to the processed state of the currently processed wafer W.

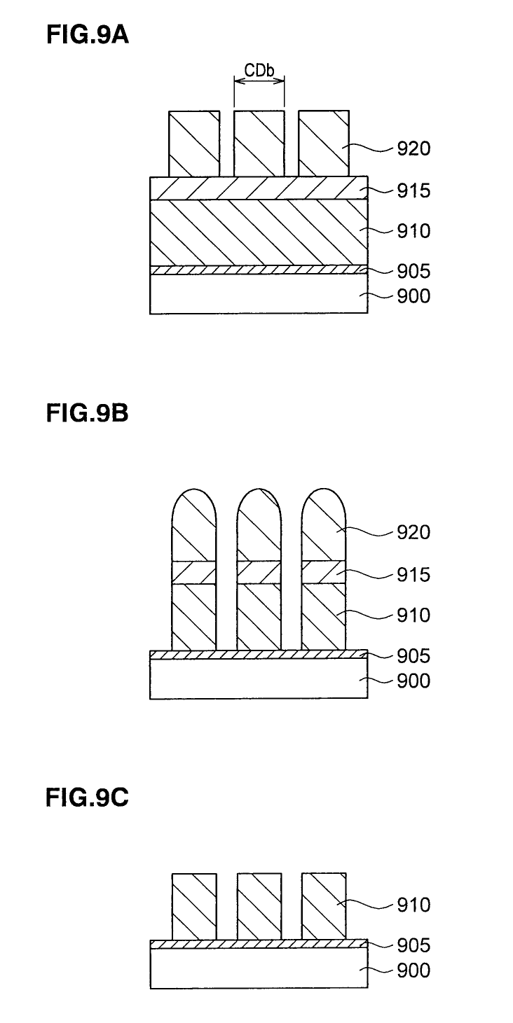

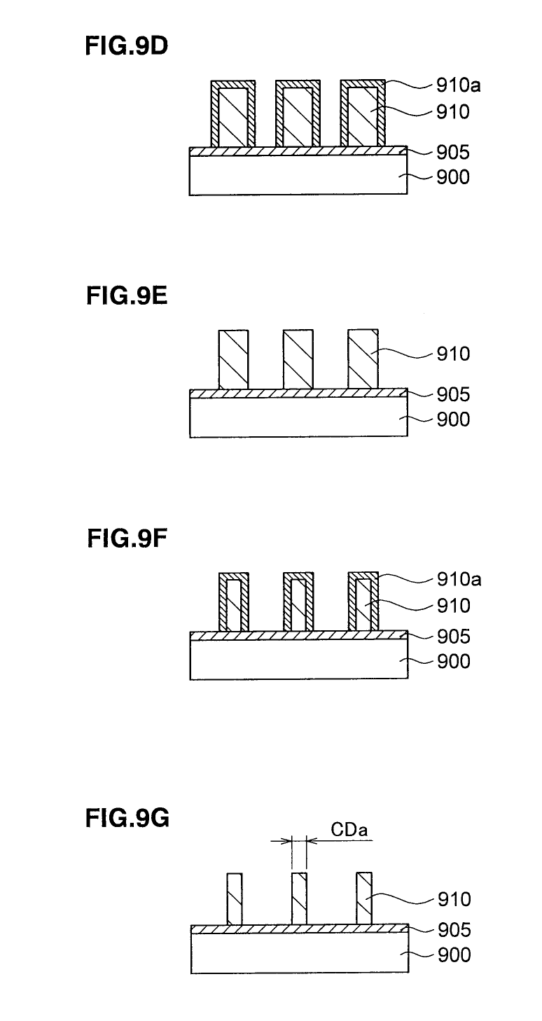

In order to compute the feedback value fₓ, the computation unit 865 first computes the pre-processing CD value (CDb in FIG. 9A), which is based on the measurement information from before the etching process, and the post-processing CD value (CDa in FIG. 9G), which is based on the measurement information from after the etching process.

Specifically, the computation unit 865 uses the equations below to determine by ellipsometry the structure of the surface of the wafer W based on the phase difference Δ between the incident light and the reflected light and on the amplitude displacement ψ, which are contained in the measurement information. The computation unit 865 then computes the CD value.

Phase difference Δ=(Wp−Ws)_{Reflected light}−(Wp−WS)_{Incident light}

Note that Wp is the phase of a p component wave of one of the incident light or the reflected light, and Ws is the phase of as component wave of one of the incident light or the reflected light.

Amplitude displacement ψ=tan⁻¹[Rp/Rs], Rp=(I_{Reflected light}/I_{Incident light})p, Rs=(I_{Reflected light}/I_{Incident light})s

Note that Ip is the intensity of the p component wave of one of the incident light or the reflected light, and Is is the intensity of the s component wave of one of the incident light or the reflected light. Rp is the reflectance ratio of the p component wave, Rs is the reflectance ratio of the s component wave.

Based on the structure of the surface of the wafer W that has been determined in this manner, the computation unit 865 determines the pre-post-processing CD value, then computes the extent to which the actual amount of material removed from the wafer W deviates from the target value. Based on the amount of the deviation, the computation unit 865 computes an optimum etching amount per unit time as the feedback value fₓ. Furthermore, in computing the target value, the computation unit 865 uses a type of moving average called an exponentially weighted moving average (EWMA) as a method of obtaining an average of the values of the feedback values fₓ over a period of time, gradually shifting the period of time for which the average is obtained to provide the moving average. EWMA is an exponential smoothing method that applies weighting such that the most recent feedback value fₓ is treated as more important than the past feedback values fₓ.

The determination unit 870 compares a value ΔFB, which is the amount of change in the feedback value fₓ computed by the computation unit 865, to a plurality of given threshold values to determine whether or not to discard the current computed feedback value fₓ. The plurality of given threshold values includes a first threshold value, a second threshold value, and a third threshold value.

The first threshold value is set in advance, according to the performance of the IMM 600, to a value (a minimum change value Ded) that is less than a lower limit value that is measurable by the IMM 600. For example, in a case where the IMM 600 can measure without error only down to the 1 nm level, the first threshold value is set to a specified value that is less than 1 nm.

The second threshold value is set in advance to a value (a maximum change value MxC) that is greater than an upper limit value that is predicted for the value of a change in the feedback value fₓ, based on an upper limit value that is predicted for the value of a change in a process condition that controls the PMs 400. Note that a parameter that serves as the process condition may be at least one of the amount of etching of the wafer W per unit time, a pressure, a power, a temperature of a specified position in the PMs 400, a mixture ratio of a plurality of types of gases, and a gas flow volume.

The third threshold value is set in advance, according to the performance of the PMs 400, to a value (a maximum limit value MxL and a minimum limit value MnL) that is the value over an upper limit value that the PMs 400 can control. That is, the third threshold value is set a value at which the PMs 400 cannot operate, due to the limits of their performance.

In a case where the determination unit 870 determines that the current computed feedback value fₓ will not be discarded, the update unit 875 incorporates the feedback value fₓ into the computation that updates the target value. On the other hand, in a case where the determination unit 870 determines that the current computed feedback value fₓ will be discarded, the update unit 875 maintains the current target value or updates the target value according to the specified threshold value. Note that the specific update method will be explained in detail later, using flow charts.

The process execution control unit 880 performs the etching process on the wafer W inside the designated PM 400 based on the sequence defined in the process recipe within the system recipe that is set in the designated strategy. In the etching process, the target value serves as the control value, and based on the target value (etching amount per unit time), the etching process is performed on the wafer W only for a length of time in which the target amount of etching can be achieved.

According to the function of each unit described above, the feedback control is performed by the functions of the computation unit 865, the determination unit 870, and the update unit 875. That is, the target value that serves as the control value during the feed forward control is optimized based on the current computed feedback value fₓ.

Furthermore, the function of the process execution control unit 880 performs the feed forward control. That is, the function of the process execution control unit 880 controls, according to the optimized target value, the etching process for the next wafer W that is transferred into the PMs 400.

Note that the functions of each unit of the TL 800 described above are actually realized by a process in which the CPU 815 in FIG. 4 reads from a storage medium, such as the ROM 805, the RAM 810, or the like, a program (including a recipe) that describes a processing sequence that realizes the functions, and the CPU 815 interprets and executes the program. For example, in the present embodiment, the various functions of the computation unit 865, the determination unit 870, the update unit 875, and the process execution control unit 880 are actually realized by the CPU 815's execution of a program that describes a processing sequence that realizes the functions.

Trimming Process

Before a feed forward/feedback control process is explained, a trimming process that is performed in the present embodiment will be explained. The trimming process is effective for making a finer line pattern on the wafer W. To be specific, ordinarily, when a specified pattern is formed on the wafer W, the technical limits of the exposure process and the development process make it difficult to form a mask layer with a line width less than approximately 0.07 μm. However, it is possible to form a line pattern with narrow lines without making the line width of the mask layer unreasonably narrow in the mask layer exposure process and development process by setting the line width of the mask layer in advance to a width that is wider than the line width that will be formed, then using the etching process to narrow (that is, trim) the line width.

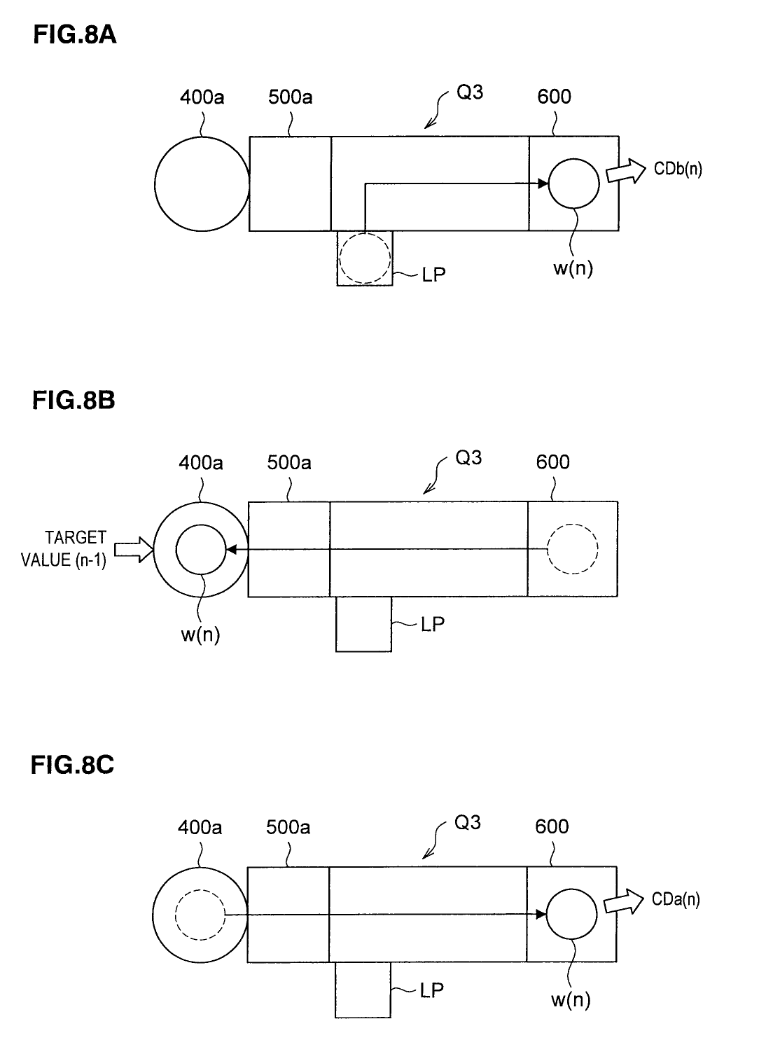

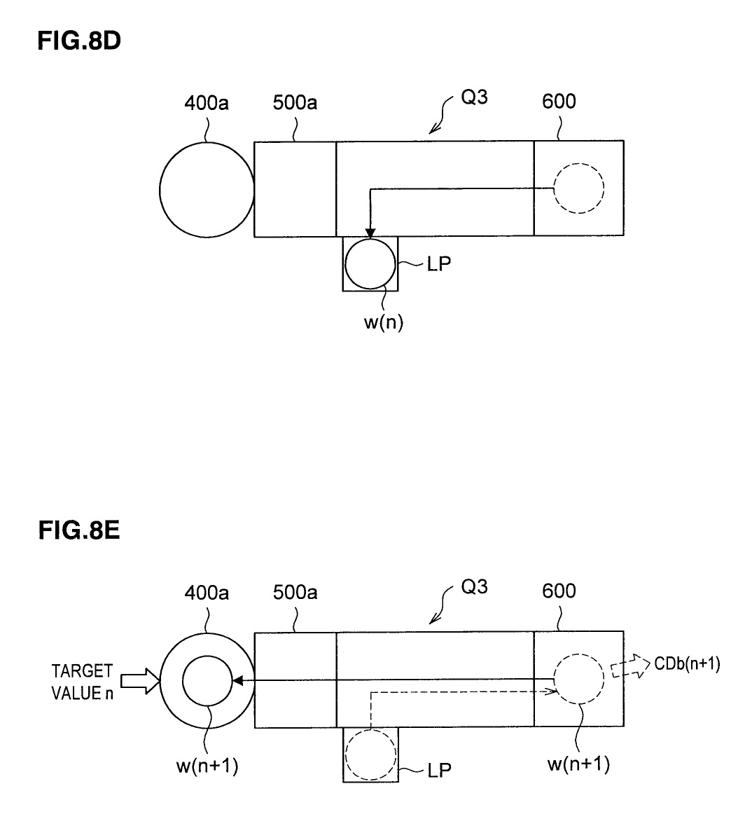

FIGS. 8A to 8E are figures that show the TRANSFER ROUTE for the wafer W in stages using simplified and schematized drawings of the system that is shown in FIG. 2. Further, FIGS. 9A to 9G are figures that show, in stages, the trimming process for a gate electrode that is formed from polysilicon (Poly-Si).

In a case where the operator starts the processing of a lot and specifies the strategy A in FIG. 6, the TRANSFER ROUTE according to the system recipe A in the strategy A is the IMM (1) to the PM 1 to the IMM (1) (the IMM 600 to the PM 400a to the IMM 600). Accordingly, as shown in FIG. 8A, the process execution control unit 880 first uses the Arm to grasp and remove the wafer W from the cassette holder LP, then operates the transfer unit Q3 to transfer the wafer W, and places the wafer W on the stage S of the IMM 600.

As shown in FIG. 9A, in the wafer W, a high-k layer 905, a gate electrode 910 that is formed from polysilicon, and an organic reflection-preventing film 915 are layered in that order on top of a substrate 900. A patterned photoresist film 920 is formed on top of the organic reflection-preventing film 915.

The IMM 600 uses the optical unit 605 that is shown in FIG. 5 to measure the shape of the surface of the wafer W that is shown in FIG. 9A and transmits the measurement information to the communication unit 855. The communication unit 855 receives the measurement information and stores it in the data base 860. Using the measurement information that is stored in the data base 860, the computation unit 865 determines by the ellipsometry method described above the structure of the surface of the wafer W and computes the pre-processing CD value (CDb in FIG. 9A). For example, assume that the pre-processing CD value (CDb) is 120 nm. In a case where the target value CD is 100 nm, the process execution control unit 880 determines that an additional 20 nm of etching is required.

After the IMM 600 measures the wafer W before the processing, the process execution control unit 880, as shown in FIG. 8B, conveys the wafer W to the PM 400a (the PM 1) according to the TRANSFER ROUTE in the system recipe, then etches the wafer W according to process recipe A.

At this time, the process execution control unit 880 uses the target value fa (the target value computed in the preceding (n−1) cycle of feedback control) that is contained in the feed forward plan A that is indicated by the strategy A to perform the feed forward control on the wafer W that was transferred into the PM 400a. The result, as shown in FIG. 9B, is that the gate electrode 910 and the organic reflection-preventing film 915 are partially etched away. Next, as shown in FIG. 9C, the process execution control unit 880, following the process recipe A, removes the photoresist film 920 and the organic reflection-preventing film 915 by ashing or the like.

Next, the process execution control unit 880 performs the trimming process in FIG. 9D. Specifically, a reactive gas is sprayed isotropically, causing the exposed surface of the gate electrode 910 to react with the reactive gas to form a reacted layer 910a that is removed. The result, as shown in FIG. 9E, is that the width of the gate electrode 910 becomes narrower. The width of the gate electrode 910 is narrowed to the width specified in the process recipe A by repeating the trimming process (FIGS. 9F and 9G).

For example, based on the determination by the computation unit 865 that an additional 20 nm of etching is required, as described above, the process execution control unit 880 predicts, based on the target value fa (20 nm of etching per 30 seconds), that 30 seconds of etching will be required to etch the 20 nm. Accordingly, the wafer W is etched for 30 seconds by a mixed gas that contains at least one of chlorine (Cl2), hydrobromic acid (HBr), hydrochloric acid (HCl), carbon tetrafluoride (CF4), and sulfur hexafluoride (SF6), which are well known as etching gases.

After the series of plasma processes described above is performed on the wafer W, the process execution control unit 880 again conveys the wafer W to the IMM 600, as shown in FIG. 8C, based on the TRANSFER ROUTE in the system recipe A. The IMM 600 again uses the optical unit 605 to measure the shape of the surface of the wafer W that is shown in FIG. 9G, then transmits the measurement information to the communication unit 855. The communication unit 855 receives the measurement information and stores it in the data base 860. Using the measurement information that is stored in the data base 860, the computation unit 865 determines by the ellipsometry method described above the structure of the surface of the wafer W and computes the post-processing CD value (CDa in FIG. 9G).

For example, assume that the post-processing CD value (CDa) is 90 nm. The determination unit 870 therefore determines that 30 nm of etching was done in 30 seconds. Accordingly, the update unit 875 updates (by feedback) the most recent target value f (feedback value fₓ) from 20 nm of etching per 30 seconds to 30 nm of etching per 30 seconds.

Next, as shown in FIG. 8D, the process execution control unit 880 returns the processed wafer W to the cassette holder LP. Then the process execution control unit 880 takes out the next wafer W, and after measuring the pre-processing state of the wafer W in the IMM 600, as shown in FIG. 8E, conveys the wafer W to the PM 400a. The process execution control unit 880 then performs the feed forward control on the wafer W based on the most recent target value fa or the most recent target value fb (the target value computed in the current (n) cycle of feedback control) that was optimized by a feedback control process.

Operation of the TL

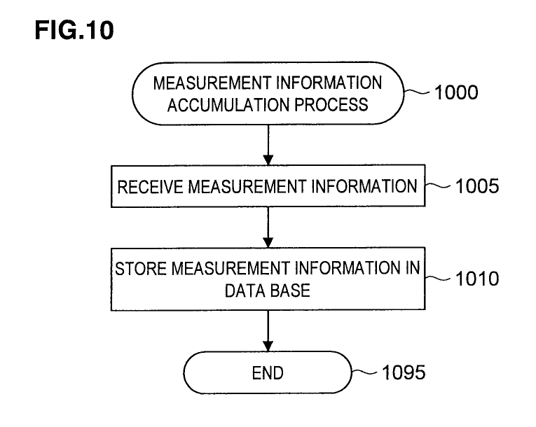

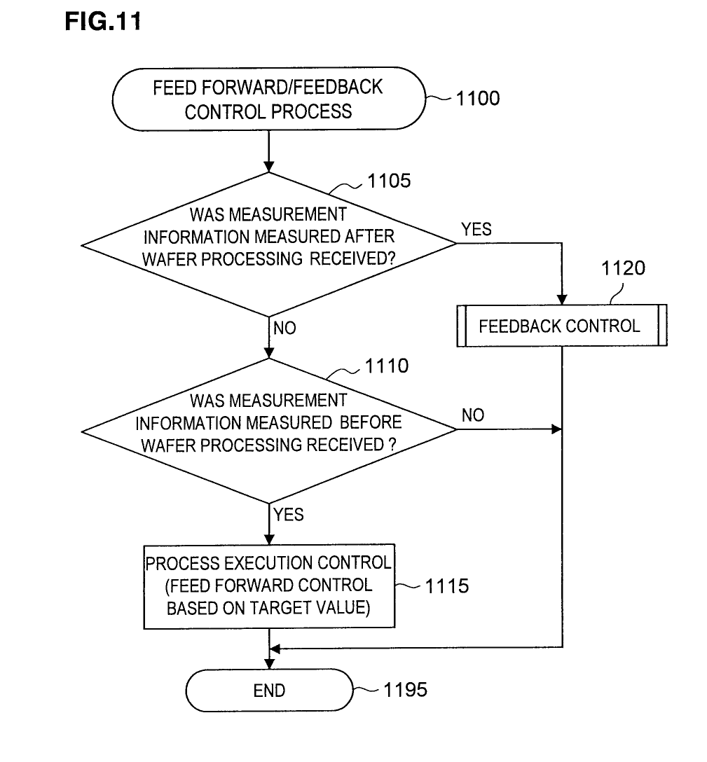

The operation of a measurement information accumulation process that is performed by the TL 800 between the plasma processes that include the trimming process described above will be explained with reference to the flow chart shown in FIG. 10. The operation of the feedback control process and a feed forward control process (process execution control processes) that are performed by the TL 800 between the executions of the measurement information accumulation process above will be explained with reference to FIG. 11.

Note that before the feedback control process starts, the target values fa, fb that serve as the control values for controlling the processing during the feed forward control process are set to etching amounts per unit time (initial values) that are specified in advance based on the process conditions. Furthermore, the measurement information accumulation process in FIG. 10 and the feed forward/feedback control process in FIG. 11 are repeatedly started at time intervals that are specified separately in advance for each process.

When the operator specifies the execution of the strategy A and turns a lot start button ON, the processing of the lot in question is started, and the 25 wafers W that are contained in the lot are transferred in order. At this time, the measurement information accumulation process also starts at step 1000 in FIG. 10, and the feed forward/feedback control process starts at step 1100 in FIG. 11.

Measurement Information Accumulation Process

Every time a specified time interval elapses, the communication unit 855 receives at step 1005 the measurement information that was measured by the IMM 600 and stores the received measurement information in the data base 860 at step 1010. The processing then ends at step 1095.

Feed Forward/Feedback Control Process

Every time a specified time interval elapses, the communication unit 855 determines at step 1105 whether or not it received the measurement information that was measured after the wafer W was processed. At this point in time, the first wafer W has not been processed. Accordingly, the communication unit 855 proceeds to step 1110 and determines whether or not it received the measurement information that was measured before the wafer W was processed. If the measurement information has not been received, then the process is ended at step 1195. On the other hand, if the measurement information has been received, the process execution control unit 880 performs the etching process (by the feed forward control) on the wafer W that was transferred into the designated PM 400. The process execution control unit 880 performs the etching process according to the process recipe A and the feed forward plan A that are indicated by the system recipe A in the strategy A that was specified by the operator from among the strategies that are stored in the storage unit 850. The process is then ended at step 1195.

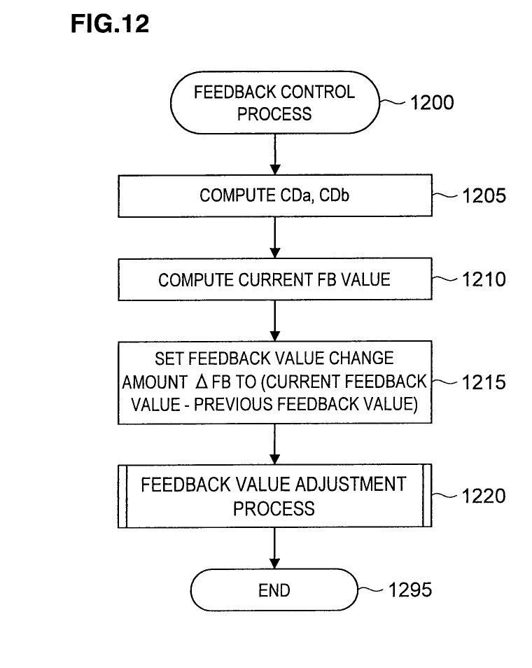

Next, when the communication unit 855 receives the measurement information that was measured after the wafer W was processed, the process proceeds to step 1120. At step 1120, the feedback (FB) control process in FIG. 12 is called and is performed by the computation unit 865, the determination unit 870, and the update unit 875 according to the feedback plan A that is stored in the storage unit 850. The process then proceeds to step 1195 and ends.

Next, the wafer W that has been transferred into the PM 400 is etched based on the target value that was optimized during the feed forward control, as described above. It is thus possible to match the process to the changes in the atmosphere inside the PM 400 such that the wafer W is processed with good precision. Note that the processing of the first wafer W is controlled by the predetermined target value, so in effect, the feed forward (FF) control that is based on the target value that is optimized by the feedback control starts with the second wafer W.

Feedback Control Process

The feedback (FB) control process that is shown in FIG. 12 starts at step 1200. At step 1205, the computation unit 865 computes CDb and CDa, which respectively express the pre-processing and post-processing states of the surface of the wafer W, based on the measurement information that was measured before the wafer W was processed and the measurement information that was measured after the wafer W was processed. Next, proceeding to step 1210, the computation unit 865 determines the extent to which the actual amount of material removed from the wafer W deviates from the target value. Based on the amount of the discrepancy, the computation unit 865 computes as the feedback value fₓ an etching amount per unit time that is estimated to be appropriate.

Next, at step 1215, the computation unit 865 determines the difference between the current computed feedback value fₓ and the feedback value fₓ computed in the preceding cycle as ΔFB, the amount of change in the feedback value fₓ. The process then proceeds to step 1220 and calls a feedback value adjustment process.

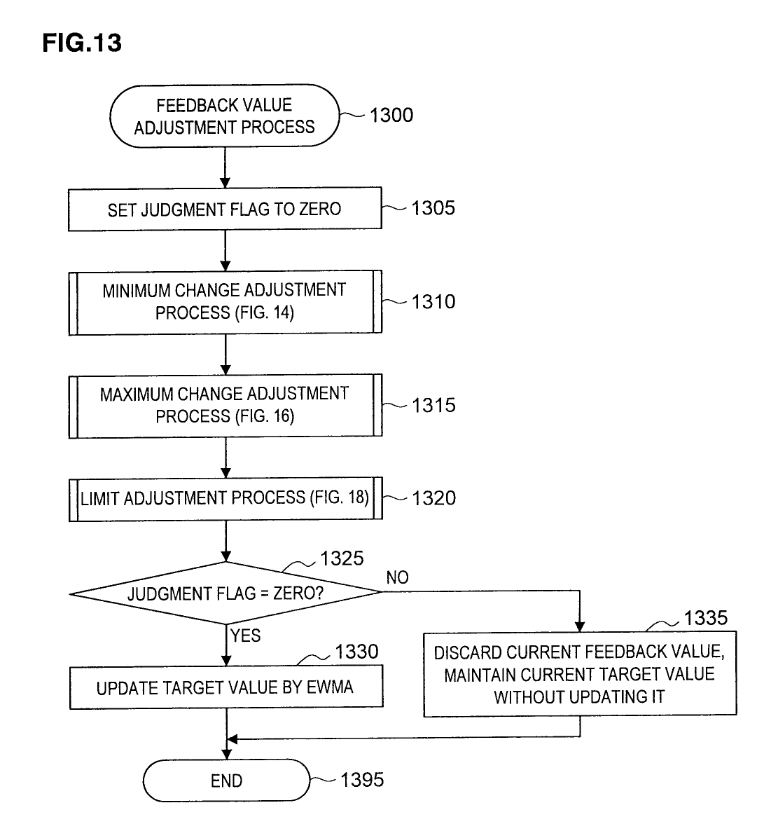

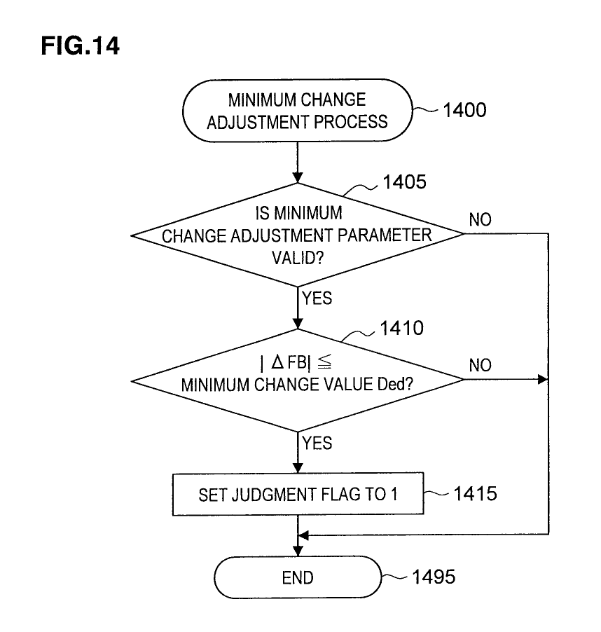

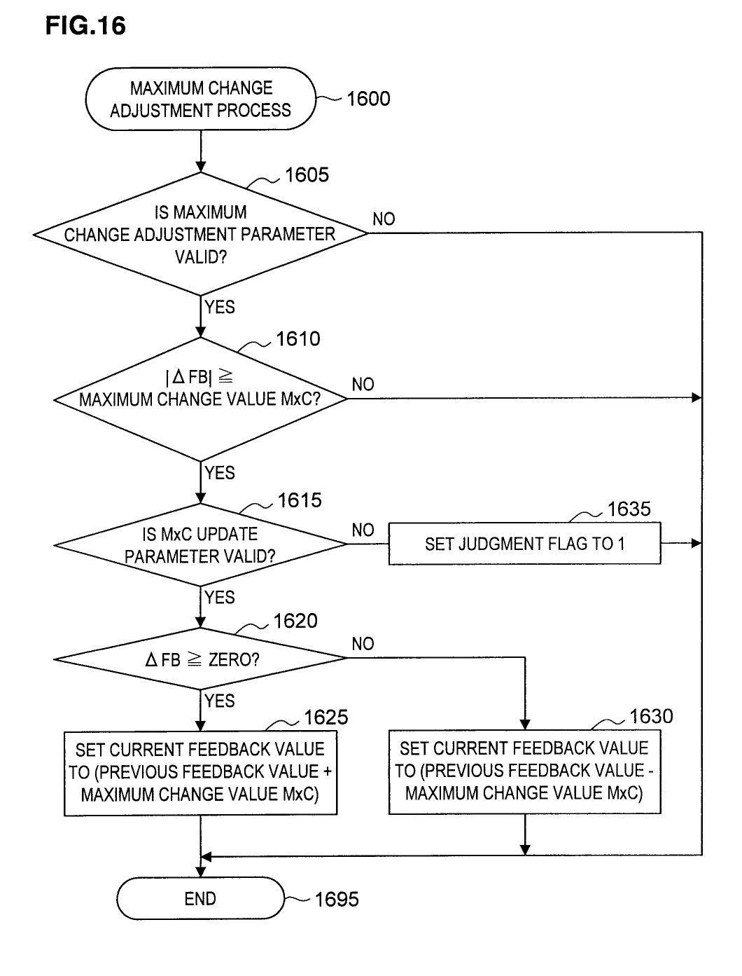

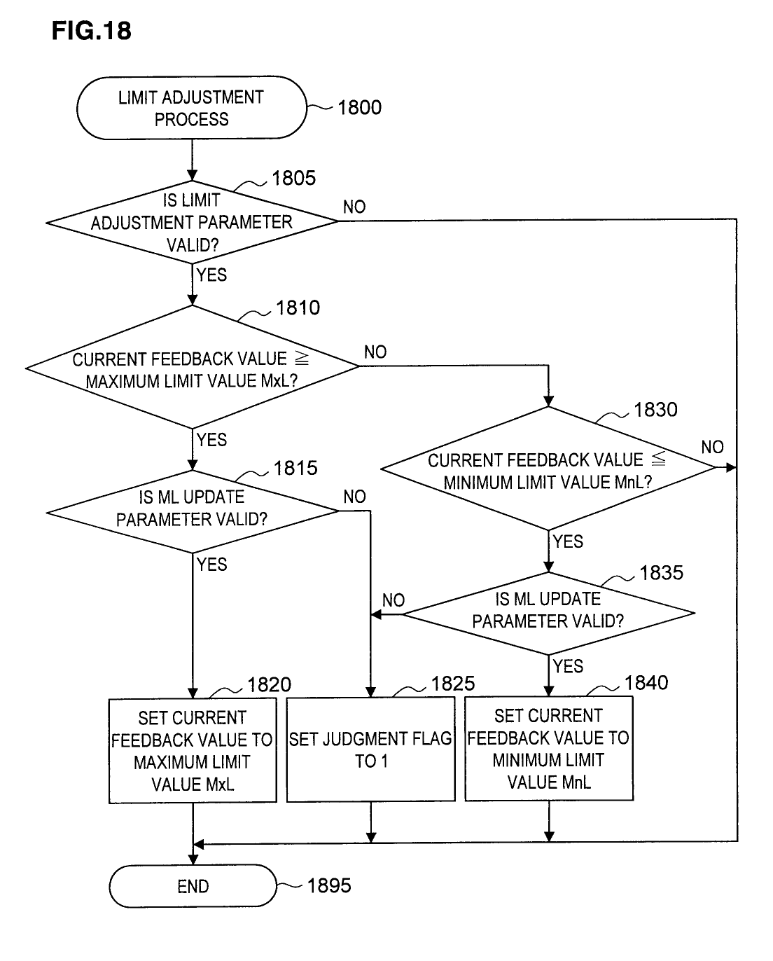

The feedback value adjustment process that is shown in FIG. 13 starts at step 1300. At step 1305, the determination unit 870 sets a judgment flag to zero (initializes the judgment flag). The determination unit 870 then performs a minimum change adjustment process (FIG. 14) at step 1310, a maximum change adjustment process (FIG. 16) at step 1315, and a limit adjustment process (FIG. 18) at step 1320.

Minimum Change Adjustment Process

The minimum change adjustment process that is shown in FIG. 14 starts at step 1400. At step 1405, the determination unit 870 determines whether or not a minimum change adjustment parameter is valid. The minimum change adjustment parameter is set to valid or invalid in advance by an operation of the operator. In a case where the minimum change adjustment parameter is valid, the determination unit 870 proceeds to step 1410 and determines whether or not the absolute value of ΔFB (the amount of change in the feedback value fₓ) is greater than the predetermined minimum change value Ded. The minimum change value Ded (which corresponds to the first threshold value) is the value that is less than the lower limit value that is measurable by the IMM 600. In a case where the absolute value of ΔFB is equal to or less than the minimum change value Ded, the determination unit 870, at step 1415, sets the judgment flag to 1 to indicate that the determination unit 870 has determined that the current computed feedback value fₓ will be discarded. The process is then ended at step 1495.

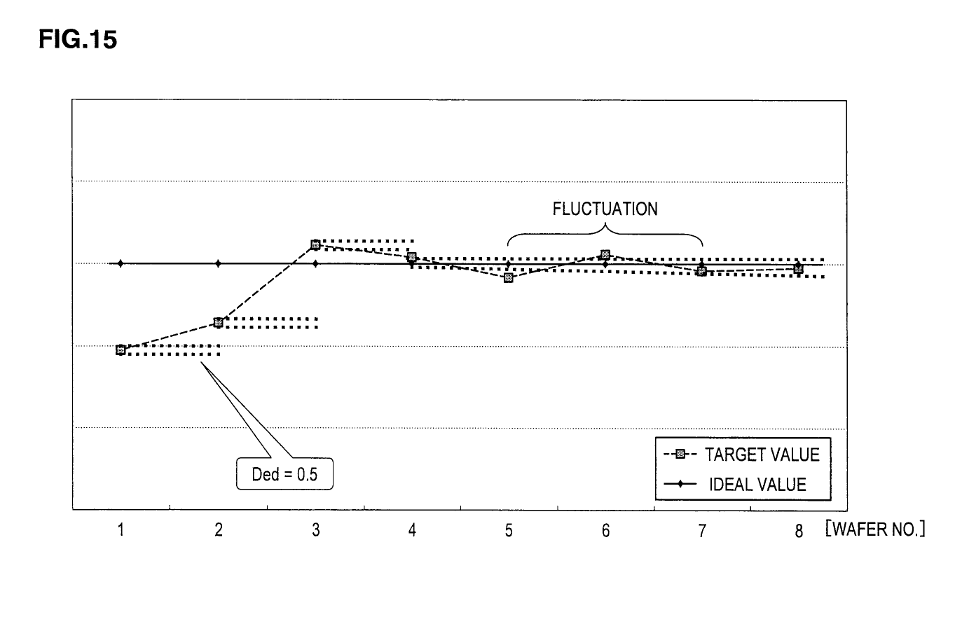

For example, in a case where the IMM 600 cannot measure down to the 1 nm level without an error, it is assumed that many measurement errors that arise from variations with values of less than 1 nm are included in changes in the feedback value fₓ. In this sort of case, if the current feedback value fₓ is used in the updating of the target value f, the measurement errors will cause the target value f to fluctuate unnecessarily in relation to an ideal value that corresponds to the current atmosphere inside the PM 400, as shown, for example, for wafers No. 5 to No. 7 in FIG. 15. The target value f will therefore deviate from the ideal value.

Accordingly, in the minimum change adjustment process, the determination unit 870 of the TL 800 determines that the current computed feedback value fₓ will be discarded in the case where the absolute value of ΔFB (the amount of change in the feedback value fₓ) is equal to or less than the minimum change value Ded. It is thus possible to avoid unnecessary fluctuation of the target value f due to the errors that occur during measurement and to maintain the target value f at or near the ideal value that varies according to the current atmosphere inside the PM 400. It is thus possible to perform the etching process with good precision on the next wafer W that is transferred into the PM 400.

Note that in a case where the minimum change adjustment parameter is determined to be invalid at step 1405, as well as in a case where the absolute value of ΔFB (the amount of change in the feedback value fₓ) is determined at step 1410 to be greater than the minimum change value Ded, no minimum change adjustment of the feedback value fₓ is necessary, and the process ends immediately.

Maximum Change Adjustment Process

After the minimum change adjustment process ends, the maximum change adjustment process that is shown in FIG. 16 starts at step 1600. At step 1605, the determination unit 870 determines whether or not a maximum change adjustment parameter is valid. The maximum change adjustment parameter is set to valid or invalid in advance by an operation of the operator. In a case where the maximum change adjustment parameter is valid, the determination unit 870 proceeds to step 1610 and determines whether or not the absolute value of ΔFB (the amount of change in the feedback value fₓ) is equal to or greater than the predetermined maximum change value MxC. The maximum change value MxC (which corresponds to the second threshold value) is the predetermined value that is greater than the upper limit value that is predicted for the value of a change in the feedback value fₓ based on the permissible upper limit value that is predicted for the value of the change in the process condition that controls the PM 400.

In a case where the absolute value of ΔFB is equal to or greater than the maximum change value MxC, the determination unit 870, at step 1615, determines whether or not an MxC update parameter is valid. The MxC update parameter is set to valid or invalid in advance by an operation of the operator. In a case where the MxC update parameter is valid, the determination unit 870 proceeds to step 1620, where it determines whether or not ΔFB (the amount of change in the feedback value fₓ) is less than zero. In a case where ΔFB (the amount of change in the feedback value fₓ) is not less than zero, the update unit 875 proceeds to step 1625, where it updates the current feedback value fₓ to the sum of the maximum change value MxC and the feedback value fₓ computed in the preceding cycle, then ends the process at step 1695. On the other hand, in a case where ΔFB (the amount of change in the feedback value fₓ) is less than zero, the update unit 875 proceeds to step 1630, where it updates the current feedback value fₓ to the value computed by subtracting the maximum change value MxC from the feedback value fₓ computed in the preceding cycle, then ends the process at step 1695.

For reasons such as that a reaction product gradually adheres to an interior wall of the PM 400 and the like, the atmosphere inside the PM 400 slowly changes over time. It is thought that the feedback value fₓ changes gradually according to the changes in the atmosphere. For this reason, in a case where the amount of change in the feedback value fₓ suddenly becomes large, for example, because of a measurement error by the IMM 600 or due to variations among the wafers W themselves, the feedback value fₓ is assumed to contain a large error. If the current computed feedback value fₓ is used in the updating of the target value f, even in this sort of case, the target value f will fluctuate greatly, and the target value f will deviate from the ideal value that corresponds to the current atmosphere inside the PM 400.

In particular, because the target value f is computed using the exponentially weighted moving average (EWMA), which is an exponential smoothing method that applies weighting such that the most recent feedback value fₓ is treated as more important than the past feedback values fₓ, any error resulting from a sudden, large change in the feedback value fₓ will affect the subsequent computations of the target value f for a long time.

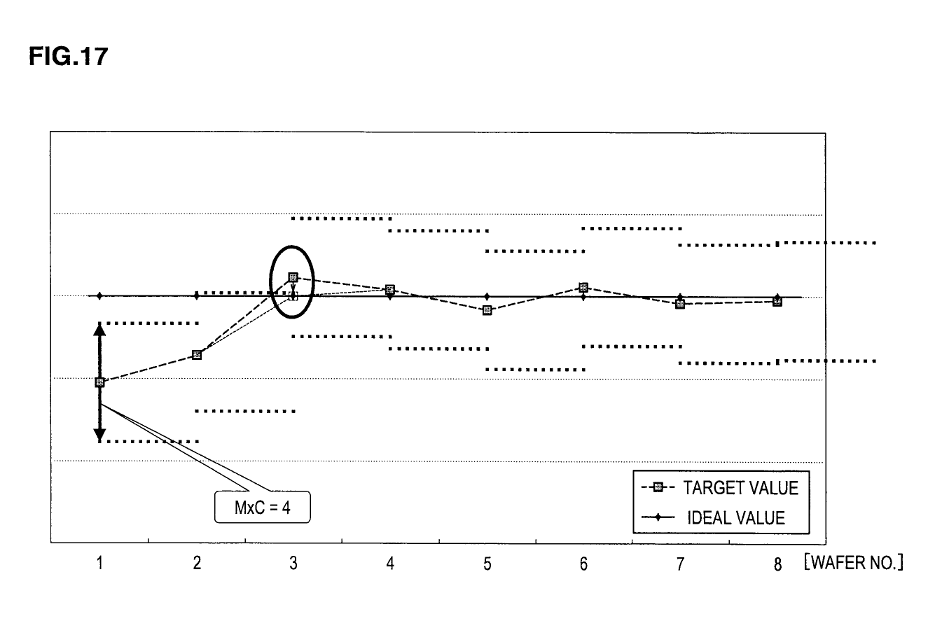

Accordingly, in a case where the absolute value of ΔFB (the amount of change in the feedback value fₓ) is equal to or greater than the maximum change value MxC, as shown by wafer No. 3 in FIG. 17, for example, the current feedback value fₓ is limited such that the absolute value of the change value ΔFB is equal to the maximum change value MxC. It is thus possible to prevent the target value f from deviating significantly from the ideal value. The result is that, based on the optimized target value f, the etching process can be performed with good precision on the next wafer W that is transferred into the PM 400.

Note that in a case where the maximum change adjustment parameter is determined to be invalid at step 1605, as well as in a case where the absolute value of ΔFB (the amount of change in the feedback value fₓ) is determined at step 1610 to be less than the maximum change value MxC, no maximum change adjustment of the feedback value fₓ is necessary, and the process immediately proceeds to step 1695, where it ends. Furthermore, in a case where the MxC update parameter is determined to be invalid at step 1615, the determination unit 870 sets the judgment flag to 1 at step 1635 to indicate that the determination unit 870 has determined that the current computed feedback value fₓ will be discarded. The determination unit 870 then proceeds to step 1695 and ends the process.

Limit Adjustment Process

The limit adjustment process that is shown in FIG. 18 starts at step 1800. At step 1805, the determination unit 870 determines whether or not a limit adjustment parameter is valid. The limit adjustment parameter is set to valid or invalid in advance by an operation of the operator. In a case where the limit adjustment parameter is valid, the determination unit 870 proceeds to step 1810 and determines whether or not the current feedback value fₓ is equal to or greater the predetermined maximum limit value MxL. The maximum limit value MxL (which corresponds to the third threshold value) is the predetermined value that is greater than the maximum limit value that the PMs 400 can control, according to the performance of the PMs 400.

In a case where the current feedback value fₓ is equal to or greater than the maximum limit value MxL, the determination unit 870, at step 1815, determines whether or not an ML update parameter is valid. The ML update parameter is set to valid or invalid in advance by an operation of the operator. In a case where the ML update parameter is valid, the update unit 875 proceeds to step 1820, where it limits the current feedback value fₓ to the maximum limit value MxL, then proceeds to step 1895 and ends the process. On the other hand, in a case where ML update parameter is invalid, the update unit 875 proceeds to step 1825, where it sets the judgment flag to 1 to indicate that the determination unit 870 has determined that the current computed feedback value f_{X} will be discarded. The process then proceeds to step 1895 and ends.

On the other hand, in a case where the current feedback value fₓ is less than the maximum limit value MxL, the determination unit 870, at step 1830, determines whether or not the current feedback value fₓ is equal to or less than the minimum limit value MnL. The minimum limit value MnL (which corresponds to the third threshold value) is the predetermined value that is less than the minus value of the maximum limit value (the minimum limit value) that the PMs 400 can control, according to the performance of the PMs 400. In a case where the current feedback value f_{X} is equal to or less than the minimum limit value MnL, the determination unit 870, at step 1835, determines whether or not the ML update parameter is valid. In a case where the ML update parameter is valid, the update unit 875 proceeds to step 1840, where it limits the current feedback value fₓ to the minimum limit value MnL, then proceeds to step 1895 and ends the process. On the other hand, in a case where ML update parameter is invalid, the update unit 875 proceeds to step 1825, where it sets the judgment flag to 1 to indicate that the determination unit 870 has determined that the current computed feedback value fₓ will be discarded. The process then proceeds to step 1895 and ends.

In a case where the current computed feedback value fₓ is a value that is greater than the maximum limit value MxL that the PMs 400 can control, due to the limits of the performance of the PM 400, as well as in a case where the current computed feedback value fₓ is a value that is less than the minimum limit value MnL that the PM 400 can control, the feedback value fₓ is assumed to be a value that has deviated from the ideal value that corresponds to the current atmosphere inside the PM 400. For example, in a case where the feedback value fₓ indicates the power that is input to the PM 400, if the current feedback value fₓ is greater than a value that can be achieved by the maximum power that can be input to the PM 400, it is inferred that the feedback value fₓ contains a large error. In this case, if the current feedback value fₓ were to be reflected in the updating of the target value f, the target value f would deviate from the ideal value that corresponds to the current atmosphere inside the PM 400.

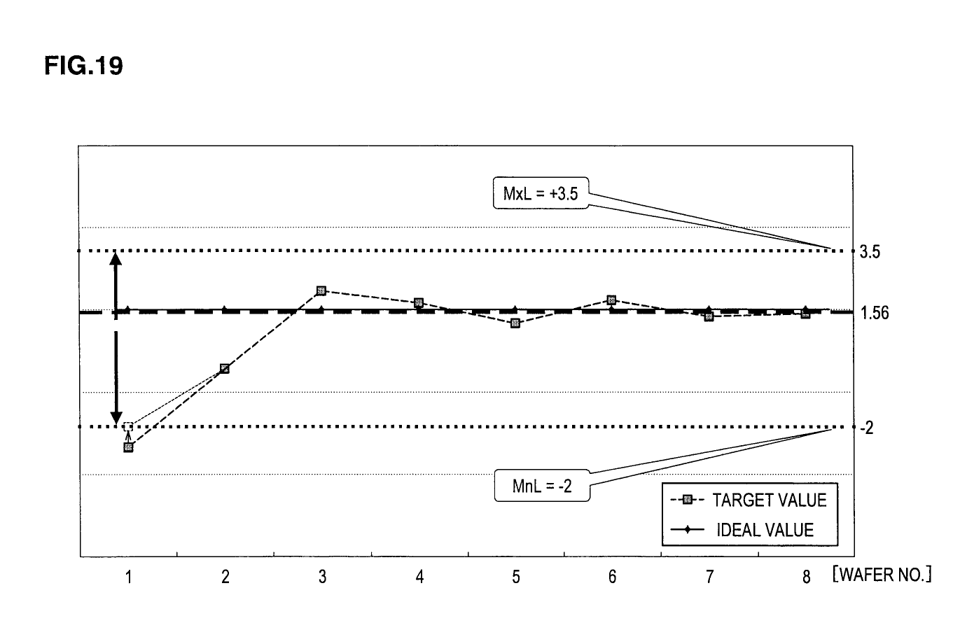

Accordingly, in a case where the current feedback value fₓ is equal to or less than the minimum limit value MnL, as shown by wafer No. 1 in FIG. 19, for example, the current feedback value fₓ is limited to the minimum limit value MnL. It is thus possible to prevent the target value f that is updated at step 1325, which is described later, from deviating significantly from the ideal value. The result is that, based on the optimized target value f, the etching process can be performed with good precision on the next wafer W that is transferred into the PM 400.

Note that in a case where the limit adjustment parameter is determined to be invalid at step 1805, as well as in a case where the feedback value fₓ is determined at step 1830 to be greater than the minimum limit value MnL, no limit adjustment of the feedback value fₓ is necessary, and the process immediately ends.

After the adjustment processes described above are completed, the feedback value adjustment process proceeds to step 1325 in FIG. 13, where the update unit 875 determines whether or not the judgment flag is set to zero. In a case where the judgment flag is set to zero, the update unit 875 proceeds to step 1330, where it uses the current feedback value fₓ in the computation of the target value f as the control value for the feedback control (in the present embodiment, the etching amount per unit time when the etching process is performed on the next wafer W). To be specific, the update unit 875 computes the target value f using the EWMA, which is the average of a group of feedback values fₓ for a period that includes the current feedback value fₓ, to which group weighting is applied before the average is computed. Then the process ends at step 1395.

On the other hand, in a case where the judgment flag is not set to zero, the update unit 875 determines that a judgment has been made to discard the current computed feedback value fₓ. At step 1335, the current feedback value fₓ is discarded, and the current target value f is maintained, without being updated. Then the process ends at step 1395.

Thus, according to the present embodiment, it is possible to prevent the target value f from deviating from the ideal value that corresponds to the current atmosphere inside the PM 400 by determining whether or not the current feedback value fₓ should be used in the updating of the target value f, based on the amount of change in the feedback value fₓ. The result is that the target value f that serves as the control value during the feedback control can be computed with better precision based on the extent of the change in the feedback value fₓ.

Note that it is acceptable to perform only one of the minimum change adjustment process and the maximum change adjustment process as the feedback value adjustment process. Furthermore, the minimum change adjustment process and the limit adjustment process may be performed without performing the maximum change adjustment process, and the maximum change adjustment process and the limit adjustment process may be performed without performing the minimum change adjustment process.

Further, in the present embodiment described above, ΔFB (the amount of change in the feedback value fₓ) is computed as the difference between the current computed feedback value fₓ and a feedback value fₓ that was computed before the current cycle. However, ΔFB (the amount of change in the feedback value fₓ) is not thus limited and may be any value that indicates the extent of the change in the feedback value fₓ. For example, ΔFB may be a ratio of the current computed feedback value fₓ to a feedback value fₓ that was computed before the current cycle.

Furthermore, in the present embodiment described above, ΔFB (the amount of change in the feedback value fₓ) is computed as the difference between the current computed feedback value fₓ and the feedback value fₓ that was computed in the preceding cycle. However, the change value ΔFB may also be computed as the difference between the current computed feedback value fₓ and at least any one feedback value fₓ that was computed before the current cycle. For example, the change value ΔFB may be computed as the difference between the current computed feedback value fₓ and the target value f.

Also, in the present embodiment described above, the TL 800 controls only the PM 400a. However, the TL 800 can control both of the PMs 400a, 400b, can provide the target value f separately for each of the PMs 400a, 400b, can determine separately whether or not to use the current computed feedback value fₓ computed separately for each of the PMs 400a, 400b in the respective updating of each of the target values f for each of the PMs 400a, 400b, and, based on the separate target values f that are determined as a result of those separate judgments, can perform the feed forward control separately for each of the wafers W that are respectively transferred into the PMs 400a, 400b.

Furthermore, the measurement information that is received by the communication unit 855 is not limited to the critical dimension (CD), but may also be the etching rate or the deposition rate.

In addition, the target value f may be a parameter that serves as a process condition. The process condition may be, for example, a substrate processing time, a pressure, a power, a temperature at a specified position in the substrate processing apparatus, a mixture ratio of a plurality of types of gases, and a gas flow volume.

### Example 1 of Change in the Layout of the Various Devices in the Area Q

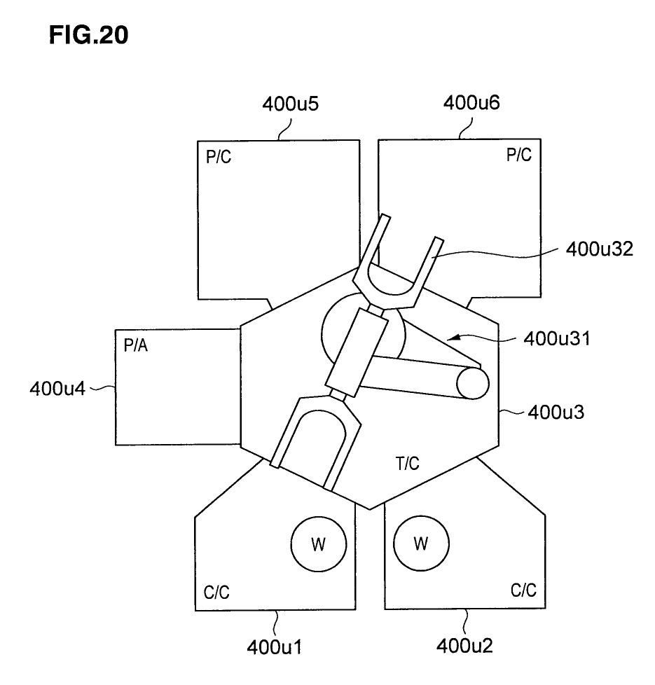

The layout of the various devices in the specified area Q within the plant is also not limited to the layout that is shown in FIG. 2. For example, the layout may be the layout that is shown in FIG. 20. In FIG. 20, cassette chambers (C/Cs) 400u1, 400u2, transfer chamber (T/C) 400u3, a pre-alignment (P/A) 400u4, and process chambers (P/Cs (equivalent to the PMs)) 400u5, 400u6 are disposed within the area Q.

Unprocessed product substrates (wafers W) and processed product substrates are accommodated in the cassette chambers 400u1, 400u2, and non-product substrates (three, for example) that are used in dummy processes are accommodated at the lowest level of a cassette. The pre-alignment 400u4 performs positioning of the wafer W.

A bendable, extendable, and rotatable multiple-jointed arm 400u31 is provided in the transfer chamber 400u3. The arm 400u31 holds the wafer W on a fork 400u32 that is provided at an end of the arm 400u31. While bending, extending, and rotating as necessary, the arm 400u31 conveys the wafer W among the cassette chambers 400u1, 400u2, the pre-alignment 400u4, and the process chambers 400u5, 400u6.

The feedback control and the feed forward control that include the feedback value adjustment process are performed based on measurement information from an IMM that is not shown in FIG. 20, even in a case where each device in the layout described above is controlled.

### Example 2 of Change in the Layout of the Various Devices in the Area Q

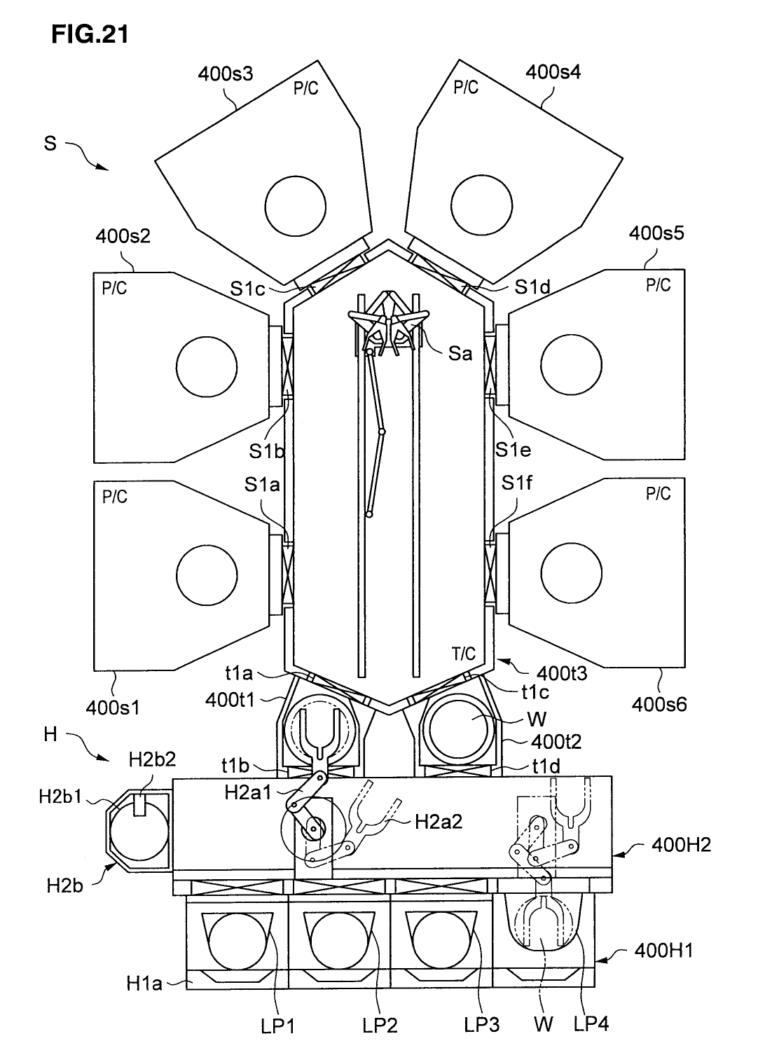

The layout of the various devices in the specified area Q within the plant may also be the layout that is shown in FIG. 21. A conveyance system H and a processing system S are disposed in the specified area Q. The conveyance system H that conveys the wafer W, and the processing system S performs the substrate processing on the wafer W, such as a deposition process, the etching process, or the like. The conveyance system H and the processing system S are linked through load lock modules (LLMs) 400t1, 400t2.

The conveyance system H includes a cassette stage 400H1 and a conveyance stage 400H2. A container carrier platform H1a is provided in the cassette stage 400H1, and four cassette containers LP1 to LP4 are placed on the container carrier platform H1a. Each of the cassette containers LP can accommodate, on a plurality of levels, unprocessed product substrates (wafers W), processed product substrates, and non-product substrates that are used for dummy processes.

On the conveyance stage 400H2, two bendable, extendable, and rotatable conveyance arms H2a1, H2a2 are supported such that they move in a sliding motion under magnetic drive. The wafers W are held by forks that are mounted on the ends of the arms H2a1, H2a2.

At one end of the conveyance stage 400H2, a positioning mechanism H2b is provided that performs positioning of the wafer W. The positioning mechanism H2b positions the wafer W by rotating a rotating platform H2b1 on which the wafer W is placed and using an optical sensor H2b2 to detect the state of the outer edge of the wafer W.

A carrier platform that carries the wafer W is provided inside each of the load lock modules 400t1, 400t2. Gate valves t1a, t1b, t1c, t1d are provided at both ends of the load lock modules 400t1, 400t2 and can open and close in an airtight manner. If this configuration is used, the conveyance system H conveys the wafer W among the cassette containers LP1 to LP 4, the load lock modules 400t1, 400t2, and the positioning mechanism H2b.

The processing system S is provided with a transfer chamber (T/C) 400t3 and six process chambers (P/Cs) 400s1 to 400s6 (equivalent to the PM 1 to the PM 6). The transfer chamber 400t3 is connected to the process chambers 400s1 to 400s6 through gate valves s1a to s1f, respectively, which can open and close in an airtight manner. A bendable, extendable, and rotatable arm Sa is provided in the transfer chamber 400t3.

If this configuration is used, the processing system S uses the arm Sa to convey the wafer W from the load lock modules 400t1, 400t2, through the transfer chamber 400t3, and to the process chambers 400s1 to 400s6. The processing system S performs a process such as the etching process or the like on the wafer W, then unloads the wafer W through the transfer chamber 400t3 to the load lock modules 400t1, 400t2.

The feedback control and the feed forward control that include the feedback value adjustment process are performed based on measurement information from an IMM that is not shown in FIG. 21, even in a case where each device in the layout described above is controlled.

Example of Change in the Internal Structure of the PMs

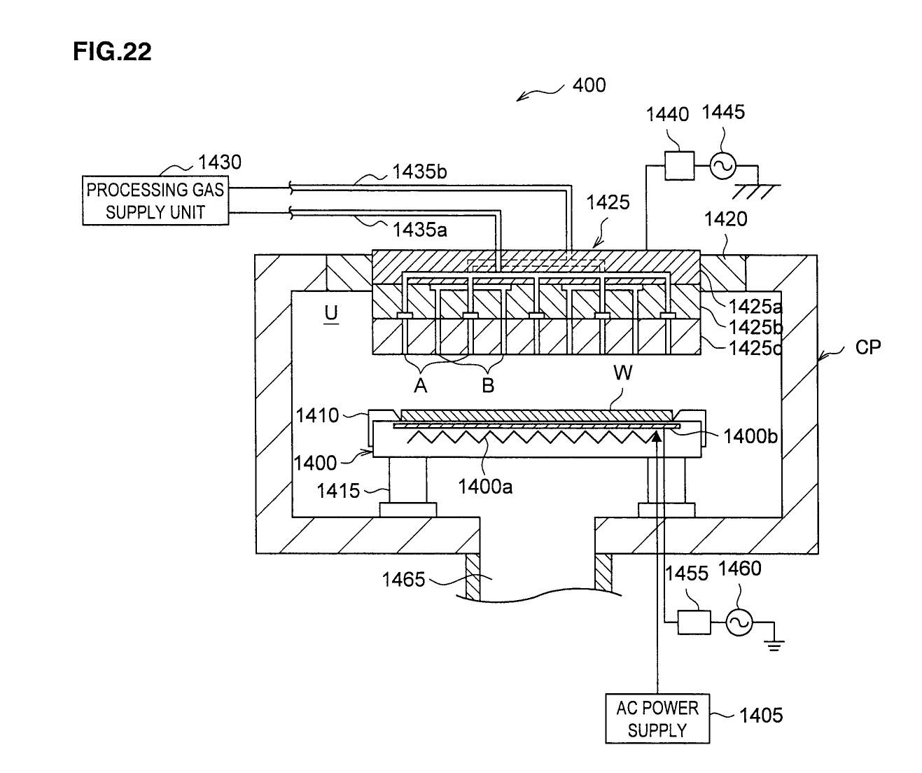

As an example of a change in the internal structure of the PMs, the PM 400 may be structured as shown by the vertical cross section in FIG. 22, for example.

The PM 400 in FIG. 22 has a circular tube-shaped processing container CP that has an airtight structure. A susceptor 1400, on which the wafer W is placed, is provided in the interior of the processing container CP. A processing chamber U that processes the wafer W is formed inside the processing container CP. A stage heater 1400a and a lower electrode 1400b are embedded in the interior of the susceptor 1400. An alternating current power supply 1405 that is provided outside the processing container CP is connected to the susceptor 1400. The wafer W is held at a specified temperature by an alternating current voltage that is output by the alternating current power supply 1405. A guide ring 1410 that guides the wafer W and focuses a plasma is provided on the outer edge of the susceptor 1400. The susceptor 1400 is supported by a circular tube-shaped supporting member 1415.

A shower head 1425 is mounted on a top unit of the processing container CP through an insulating material 1420. The shower head 1425 is made up of an upper-level block 1425a, a mid-level block 1425b, and a lower-level block 1425c. Two gas channel systems that are formed in each of the blocks 1425a, 1425b, 1425c are respectively continuous with gas injection holes A and gas injection holes B that are formed in alternation in the lower-level block 1425c.

A processing gas supply unit 1430 supplies various types of gases selectively to the interior of the processing container CP. Specifically, the processing gas supply unit 1430 selectively supplies a specified gas to the interior of the processing container CP from the injection holes A through a gas line 1435a. The processing gas supply unit 1430 also selectively supplies a specified gas to the interior of the processing container CP from the injection holes B through a gas line 1435b.

A high-frequency power supply 1445 is connected to the shower head 1425 through a matching box 1440. On the other side of the processing container CP, a high-frequency power supply 1460 is connected through a matching box 1455 to the lower electrode 1400b that is provided in the interior of the susceptor 1400 as an opposing electrode to the shower head 1425. A specified bias voltage is applied to the lower electrode 1400b by the high-frequency electric power that is output from the high-frequency power supply 1460. A specified degree of vacuum is maintained inside the processing container CP by an exhaust mechanism not shown in FIG. 22 that is continuous with an exhaust pipe 1465.

If this configuration is used, the gas that is injected into the processing container CP through the shower head 1425 from the processing gas supply unit 1430 is excited to generate a plasma by the high-frequency electric power that is supplied to the shower head 1425 from the high-frequency power supply 1445. The plasma causes a desired film to form on the wafer W.

According to the layouts of the various devices in the examples 1 and 2 described above, and according to the internal structure of the PM 400 in the example described above, it is possible to prevent the target value f from deviating from the ideal value that corresponds to the current atmosphere inside the PM 400 by determining whether or not the current feedback value fₓ should be used in the updating of the target value f, based on the amount of change in the feedback value fₓ. The result is that the target value f that serves as the control value during the feed forward control can be computed with better precision based on the extent of the change in the feedback value fₓ.

In the above embodiments, the operations of the units are related to each other. The operations may thus be replaced with a series of operations in consideration of the relations. The operations of the units (the control device for the substrate processing apparatus) may also be replaced with the processes by the units (the control method for the substrate processing apparatus), thus providing program embodiments. The program may be stored in a computer-readable storage medium, thus changing the program embodiment to a computer-readable storage medium embodiment recording the program.

The preferred embodiment of the present invention has been described with reference to the appended drawings, but it is clearly apparent that the present invention is not limited by this example. It should be understood by those skilled in the art that various modifications, combinations, sub-combinations and alterations may occur depending on design requirements and other factors insofar as they are within the scope of the appended claims or the equivalents thereof.

For example, the substrate processing apparatus according to the present invention may also be one of a microwave plasma substrate processing apparatus, an inductively coupled plasma substrate processing apparatus, and a capacitively coupled plasma substrate processing apparatus.

Furthermore, the substrate processing that is performed by the substrate processing apparatus according to the present invention is not limited to the etching process, but may also be any sort of substrate processing, such as a thermal diffusion process, an deposition process, an ashing process, a spattering process, and the like.

The controlling device for the substrate processing apparatus according to the present invention may also be embodied by the TL 800 alone and may also be embodied by the TL 800, the EC 200, and the MC 300.

What is claimed is:

1. A controlling device for a substrate processing apparatus that performs a specified process on a substrate, the controlling device comprising:
a storage unit that stores a specified target value that serves as a control value when the specified process is performed on the substrate;
a communication unit that causes a measuring device to measure measurement information including a processing state of the substrate that is processed by the substrate processing apparatus and receives the measurement information;
a computation unit that computes a feedback value that corresponds to a processed state of the substrate processed in the current cycle, based on pre-processing and post-processing measurement information for the substrate processed in the current cycle within the measurement information received by the communication unit, and that also computes a feedback value change value between the current computed feedback value and at least any one of feedback values that was computed before the current cycle;
a determination unit that determines whether or not to discard the current computed feedback value by comparing the computed feedback value change value to a given threshold value; and
an update unit that, in a case where the determination unit determines that the current computed feedback value will not be discarded, uses the current computed feedback value in updating the target value that is stored in the storage unit.

2. The controlling device for the substrate processing apparatus according to claim 1, wherein
the given threshold value includes a first threshold value,
the first threshold value is set in advance, according to the performance of the measuring device, to a value that is less than a lower limit value that is measurable by the measuring device,
the determination unit, in a case where the absolute value of the feedback value change value is equal to or less than the first threshold value, determines that the current computed feedback value will be discarded, and
the update unit, in a case where the determination unit determines that the current computed feedback value will be discarded, maintains the target value as is, without updating it.

3. The controlling device for the substrate processing apparatus according to claim 1, wherein
the given threshold value includes a second threshold value,
the second threshold value is set in advance, based on a permissible upper limit value for the value of a change in a process condition that controls the substrate processing apparatus, to a value that is greater than an upper limit value that is predicted as the feedback value change value,
the determination unit, in a case where the absolute value of the feedback value change value is equal to or greater than the second threshold value, determines that the current computed feedback value will be discarded, and
the update unit, in a case where the determination unit determines that the current computed feedback value will be discarded, does one of maintaining the target value as is, without updating it, and updating the target value corresponding to the second threshold value.

4. The controlling device for the substrate processing apparatus according to claim 2, wherein
the given threshold value includes a third threshold value,
the third threshold value is set in advance, according to the performance of the substrate processing apparatus, to a value that is greater than an upper limit value that the substrate processing apparatus can control,
the determination unit, in a case where the current computed feedback value is equal to or greater than the third threshold value, determines that the current computed feedback value will be discarded, and
the update unit, in a case where the determination unit determines that the current computed feedback value will be discarded, does one of maintaining the target value as is, without updating it, and updating the target value corresponding to the third threshold value.

5. The controlling device for the substrate processing apparatus according to claim 1, further comprising:
a process execution control unit that, when the specified process is performed on the substrate that is transferred into the substrate processing apparatus, performs the specified process to the substrate with a feed forward control based on the target value that is stored in the storage unit.

6. The controlling device for the substrate processing apparatus according to claim 5,
wherein the controlling device controls a plurality of the substrate processing apparatuses,
provides the target value separately for each of the substrate processing apparatuses,
determines separately whether or not to use the current computed feedback value computed in the respective updating of each of the target values for each of the substrate processing apparatuses, and
separately performs, based on each of the target values that are determined as a result of the separate determinations, the feed forward control for each of the substrates that are transferred into each of the respective substrate processing apparatuses.

7. The controlling device for the substrate processing apparatus according to claim 1, wherein the computation unit computes the feedback value change value between the current computed feedback value and the feedback value that was computed in the preceding cycle.

8. The controlling device for the substrate processing apparatus according to claim 1, wherein the computation unit computes the feedback value change value between the current computed feedback value and the target value.

9. The controlling device for the substrate processing apparatus according to claim 1, wherein the received measurement information is information for computing at least one of a substrate critical dimension, an etching rate, and a deposition rate.

10. The controlling device for the substrate processing apparatus according to claim 1, wherein the target value is a parameter that serves as a process condition.

11. The controlling device for the substrate processing apparatus according to claim 10, wherein the parameter that serves as a process condition is at least one of a substrate processing time, a pressure, a power, a temperature of a specified position in the substrate processing apparatus, a mixture ratio of a plurality of types of gases, and a gas flow volume.

12. The controlling device for the substrate processing apparatus according to claim 1, wherein the specified process is an etching process.

13. A control method for controlling a substrate processing apparatus that performs a specified process on a substrate, comprising:
storing in a storage unit a specified target value that serves as a control value when the specified process is performed on the substrate;
causing a measuring device to measure measurement information including a processing state of the substrate that is processed by the substrate processing apparatus;
receiving the measurement information;
computing a feedback value that corresponds to a processed state of the substrate processed in the current cycle, based on pre-processing and post-processing measurement information for the substrate processed in the current cycle within the received measurement information;
computing a feedback value change value between the current computed feedback value and at least any one of feedback values that was computed before the current cycle;
determining whether or not to discard the current computed feedback value by comparing the computed feedback value change value to a given threshold value; and
in a case where it is determined that the current computed feedback value will not be discarded, using the current computed feedback value in updating the target value that is stored in the storage unit.

14. A storage medium that stores a control program for a substrate processing apparatus that performs a specified process on a substrate, to control the substrate processing apparatus by executing the control program with a computer, the control program comprising:
a module stores in a storage unit a specified target value that serves as a control value when the specified process is performed on the substrate;
a module that causes a measuring device to measure measurement information including a processing state of the substrate that is processed by the substrate processing apparatus, and that receives the measurement information;
a module that computes a feedback value that corresponds to a processed state of the substrate processed in the current cycle, based on pre-processing and post-processing measurement information for the substrate processed in the current cycle within the received measurement information, and that also computes a feedback value change value between the current computed feedback value and at least any one of feedback values that was computed before the current cycle;
a module that determines whether or not to discard the current computed feedback value by comparing the computed feedback value change value to a given threshold value; and
a module that, in a case where it is determined that the current computed feedback value will not be discarded, uses the current computed feedback value in updating the target value that is stored in the storage unit.
